(19) United States
(12) Patent Application Publication
(10) Pub. No.: US 2021/0065259 A1
(43) Pub. Date: Mar. 4, 2021

(54) METHOD, SYSTEM AND COMPUTER PROGRAM PRODUCT FOR SELECTING AND TRACKING A SERVICE PROVIDER IN RESPONSE TO A CUSTOMER REQUEST

(71) Applicant: Jimmy Luong, Diamond Bar, CA (US)

(72) Inventor: Jimmy Luong, Diamond Bar, CA (US)

(21) Appl. No.: 16/560,755

(22) Filed: Sep. 4, 2019

(51) Int. Cl. G06Q 30/02; G06Q 30/00

(52) U.S. Cl. CPC G06Q 30/0282; G06Q 30/016

(57) ABSTRACT

Embodiments disclosed herein relate to communication of a task-related request from a requester to service providers. The task-related request may specify a set of parameters, including a task completion location and a representation of the task related request. The service providers may be differentiated based on distance from each service provider to the requester. A price quote may be aggregated from each service provider with the distance from that service provider to the requester and related publicly-available ratings and reviews for that service provider to generate a service provider score for that service provider. Upon receiving corresponding input from the requester, selection of an optimal service provider may be made from the service providers according to its total service provider score. Tracked movement of the optimal service provider from its initial start location to the task completion location may be displayed to the requester.

### TECHNICAL FIELD

The present disclosure generally relates to the process of providing real-time geographic tracking information of a service provider traveling en route to a task completion location in response to a request placed by a customer; and, more particularly, is concerned with a process involving computer-assisted intelligent and/or human-based recognition of a particular task, where a depiction of that task may be electronically forwarded to real service providers for, for example, the hierarchical ranking of the service providers based on a number of factors, including distance from the task completion location, quoted prices for services intended to be rendered, and overall match of the service providers capabilities and/or skills and the type of task requested for completion.

### BACKGROUND

The proliferation of ride-sharing services in the recent past has drastically changed the business landscape in which professional goods and services are procured. Due to efficiencies inherent in partial actual vehicle utilization as made possible via strategic ride-share implementation, many patrons are able to traverse distances, long and short, with ease and minimal necessity of personal vehicle ownership. Doing so has correspondingly yielded predictable vehicle deterioration schedules, allowing for vehicle owners to plan for routine maintenance in advance, etc. Largely due to the conveniences introduced by ride-sharing for human customers, e.g., travelers, etc., ride-sharing has recently also found usage in the delivery of items, e.g., food. Accordingly, food purchasers may communicate their desire for particular items by placing an order via a smartphone enabled application, e.g., an “app”, where such demands are forwarded and/or electronically communicated to a corresponding food delivery driver who receives the order and proceeds to travel to the restaurant and/or food store location to retrieve the ordered items to then deliver the same to the customer for payment.

Similar solutions are needed in ancillary industries, including the “handy-person” industry, e.g., referring to the completion of odd jobs around the house, not particularly rising to the level of requiring the expertise of a skilled para-professional, such as a plumber, electrician, mechanic and/or the like, but nevertheless likely too challenging for the average layperson, who may be largely uneducated in the specifics of successfully completing tasks such as installing grouting, replacing cabinetry, installing a replacement toilet and/or sink, removing and/or replacing carpeting, and/or the like. Although customers requiring such services may turn to such oriented apps, these apps may fail to provide a single-stop solution, conveniently itemizing and organizing service providers into a convenient hierarchy, e.g., referring to ordering prospective service providers based on several factors relating to service provider relevancy, including: geographic proximity of the task and/or service provider to the intended job site location, the relative qualification levels of the service providers, such as having passed certain certifications, licensures, minimum bond and/or insurance particularities, years of service, etc. Moreover, customers must still describe the task required for completion by writing a detailed description thereof, often an arduous and time-consuming process that may otherwise be replaced by the implementation of advanced computer-based visual recognition technology, which may recognize a task based on a detected representative image thereof, e.g., cable management as associated with the set-up of a new home office workstation, etc.

Solutions have been long sought but prior developments have not taught or suggested any complete solutions, and solutions to these problems have long eluded those skilled in the art. Thus, there remains a considerable need for devices and methods that can provide immediate visual recognition of a task intended for completion by a service provider for efficient matching purposes between the task as requested by the customer and the service provider's ability to fulfill said task, where the whereabouts of the service provide are tracked in an app for viewing by the customer requesting completion of the task.

### SUMMARY

An embodiment relates to a non-transitory computer-readable storage medium storing one or more executable programs thereon, wherein the program instructs one or more processors to perform the following steps: communicate, over a network, a task-related request from a requester to one or more service providers, the task-related request specifying a set of parameters, including a task completion location and a representation of the task related request; differentiate the one or more service providers based on distance from each service provider to the requester; aggregate a price quote from each service provider with the distance from that service provider to the requester and related publicly-available ratings and reviews for that service provider to generate a service provider score for that service provider; select, upon receiving corresponding input from the requester, an optimal service provider from the one or more service providers according to its total service provider score; and display tracked movement of the optimal service provider from its initial start location to the task completion location to the requester.

The differentiation of the one or more service providers may further involve: determining a trip completion time for each service provider to arrive at the task completion location; determining one or more preferred service providers based on a hierarchical ranking of the trip completion times for each service provider; and restricting the selection of the optimal service provider, by the requester, to the one or more preferred service providers.

The task related request may be selected from a group consisting of: an image, an audio recording, a text, and a video.

An electronic payment form is provided to the requester for submission of monetary payment therein once the optimal service provider satisfactorily completes the task-related request.

The representation of the task related request may be identified at least partially based on contents thereof such that the identifying may at least partially involve functionality associated with one or more capabilities selected from a group consisting of: artificial intelligence, machine learning, and computer-performed functions that mimic human cognitive functions.

A network computer system comprising: one or more processors; a set of memory resources to store a set of instructions that, when executed by the one or more processors, may cause the one or more processors to: forward, over a network, a request from a customer regarding the scheduling of a task to a group of service providers, the request including a task completion location and a visual and/or audial representation of the task; identifying, at least partially relying on artificial intelligence, the task based on the visual and/or audial representation thereof, to produce an identification of the task; cross-referencing the identification of the task with one or more service providers from the group of service providers who are within a defined maximum radius from the task completion location and who are skilled to perform the task to define a sub-set of preferred service providers; organizing the sub-set of preferred service providers based on price quote information provided by each of the sub-set of preferred service providers to produce a hierarchy, lower price quotes receiving greater weightage resulting in preferential placement on the hierarchy; displaying the hierarchy to the customer to permit for selection of an optimal service provider by the customer from the sub-set of preferred service providers; reserving the optimal service provider at the task completion location at an appointment time; and tracking movement of the optimal service provider from its start location to the task completion location.

The tracking may at least partially involve usage of global positioning service functionality.

The identifying the task at least partially relying on artificial intelligence may further involve: usage of machine learning to automatically self-update to more accurately identify given tasks upon observing several iterations of a same or similar task.

Data related to a frequency of requests and successful payment history of the customer may be communicated to the group of service providers for assessment by each service provider.

A method for selecting a service provider over a network system, the method involving: determining, based at least partially on input data from a client device, that a customer has initiated a task request by specifying a particular task from a group of available tasks; cross-referencing the task selected by the customer against a group of service providers within a pre-defined service area of the customer; linking the customer to one or more service providers based on: (1) the particular task specified from the group of tasks; and, (2) any given service provider's ability to successfully complete the particular task within a prescribed time of arrival and duration of completion; organizing linked service providers into a hierarchy based on price quotes for completing the task provided by each service provider; presenting the hierarchy to the customer for the selection of an optimal service provider therefrom; and displaying tracking information of the optimal service provider from its start location to the customer.

The group of available tasks may include: bathroom fixtures, bathroom remodels, cabinetry, carpentry, carpet, chimneys and fireplaces, decks, doors, drywall, electrical, fencing, garage doors, gas installation and repair, gutters, heating, ventilation, and cooling, indoor and outdoor lighting, kitchen fixtures, kitchen remodels, laminate flooring, leak detection and repair, locksmith services, masonry, painting, plumbing, roofing, sewers and drains, sprinklers, swimming pools, tile flooring, wallpaper, windows, and wood flooring.

The group of available tasks may include any one selected from a group consisting of: clean-outs, gardening, house cleaning, moving, snow removal, and tree service.

The group of available tasks may include providing service to any one selected from a group consisting of: audio-visual equipment, cell phones, desktop computers, laptops, modems/routers, tablets, televisions, and portable electronic devices.

Other contemplated embodiments can include objects, features, aspects, and advantages in addition to or in place of those mentioned above. These objects, features, aspects, and advantages of the embodiments will become more apparent from the following detailed description, along with the accompanying drawings.

### BRIEF DESCRIPTION OF THE FIGURES

The process of providing real-time geographic tracking data of a service provider traveling en route to a task completion location in response to a request placed by a customer (and, in some embodiments, the hierarchical ranking of service providers based on proximity to the job site location and/or suitability for completing the task successfully) is illustrated in the figures of the accompanying drawings which are meant to be exemplary and not limiting, in which like reference numerals are intended to refer to like components, and in which:

FIG. 1 illustrates an exemplary schematic diagram of a customer-initiated service request fulfillment system for various example tasks, in accordance with an embodiment of the presently disclosed embodiments;

FIG. 2 illustrates an example “cloud”-based system for providing real-time geographic tracking data of a service provider traveling en route to a task completion location in response to a request placed by a customer, in accordance with an embodiment of the presently disclosed embodiments;

FIG. 3 illustrates an example arrangement of functional modules, at least partially executed on computer hardware, for the operation of a customer-initiated service request fulfillment system, in accordance with an embodiment of the presently disclosed embodiments;

FIG. 4 illustrates various screen captures of a computer-based application, e.g., an “app”, related to the identification of a geographic location of a task intended for completion and input of various request related data further characterizing the specifics of the task, in accordance with an embodiment of the presently disclosed embodiments;

FIG. 5 illustrates additional screen captures of the app related to the recording of an audial representation of the task intended for completion, booking of the task, and general customer profile related settings, in accordance with an embodiment of the presently disclosed embodiments; and

FIG. 6 illustrates a block diagram depicting an example client/server system which may be used by an example web-enabled/networked embodiment of the presently disclosed embodiments.

Unless otherwise indicated illustrations in the figures are not necessarily drawn to scale.

### DETAILED DESCRIPTION OF SOME EMBODIMENTS

### Background and Context

The disclosed embodiments are best understood by reference to the Figures and detailed description herein.

Disclosed embodiments of the invention are discussed below with reference to the Figures. However, those skilled in the art will appreciate that the detailed description provided herein with respect to these figures is for explanatory purposes as the invention may extends beyond these currently disclosed embodiments. Various alternate approaches to implement the functionality of any given detail described herein is envisioned. That is, there are modifications and variations of the invention that are too numerous to be listed but that all fit within the scope of the invention. Also, singular words should be read as plural and vice-versa, where appropriate, and alternative embodiments do not imply mutual exclusivity.

It is to be further understood that the disclosed embodiments are not necessarily limited to the particular methodology, techniques, uses, and applications, described herein, as these may vary. It is also to be understood that the terminology used herein is used for the purpose of describing particular embodiments only, and is not otherwise intended to limit the scope of the present invention. It must be noted that as used herein in the detailed description and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Physical and/or conceptual structures described herein are to be understood also to refer to functional equivalents of such structures.

All words of approximation as used in the present disclosure and claims should be construed to mean “approximate,” rather than “perfect”. Words of approximation, include, yet are not limited to terms such as “substantial”, “nearly”, “almost”, “about”, “generally”, “largely”, etc.

Terms of degree are not necessarily indefinite. “Claim language employing terms of degree has long been found definite where it provided enough certainty to one of skill in the art when read in the context of the invention.” Interval Licensing LLC v. AOL, Inc., 766 F.3d 1364, 1370, 112 USPQ2d 1188, 1192-93 (Fed. Cir. 2014) (citing Eibel Process Co. v. Minnesota & Ontario Paper Co., 261 U.S. 45, 65-66 (1923. Thus, when a term of degree is used in the claim, the examiner should determine whether the specification provides some standard for measuring that degree. Hearing Components, Inc. v. Shure Inc., 600 F.3d 1357, 1367, 94 USPQ2d 1385, 1391 (Fed. Cir. 2010); Enzo Biochem, Inc., v. Applera Corp., 599 F.3d 1325, 1332, 94 USPQ2d 1321, 1326 (Fed. Cir. 2010); Seattle Box Co., Inc. v. Indus. Crating & Packing, Inc., 731 F.2d 818, 826, 221 USPQ 568, 574 (Fed. Cir. 1984).

The term “substantially” is often used in conjunction with another term to describe a particular characteristic of the claimed invention. It is a broad term. In re Nehrenberg, 280 F.2d 161, 126 USPQ 383 (CCPA 1960). The court held that the limitation “to substantially increase the efficiency of the compound as a copper extractant” was definite in view of the general guidelines contained in the specification. In re Mattison, 509 F.2d 563, 184 USPQ 484 (CCPA 1975).

All questions of enablement are evaluated against the claimed subject matter. The focus of the examination inquiry is whether everything within the scope of the claim is enabled.

Unless defined otherwise, all technical and scientific terms used herein have the same meanings as commonly understood by one of ordinary skill in the art to which the disclosed embodiments belong. Preferred methods, techniques, devices, and materials are described, although any methods, techniques, devices, or materials similar or equivalent to those described herein may be used in the practice or testing of the present invention.

Although Claims have been included in this Application to specific enumerated combinations of features, it should be understood that the scope of the present disclosure also includes any novel feature or any novel combination of features disclosed herein.

References “an embodiment,” “example embodiment,” “various embodiments,” “some embodiments,” etc., may indicate that the embodiment(s) so described may include a particular feature, structure, or characteristic, but not every possible embodiment necessarily includes that particular feature, structure, or characteristic.

References to “user”, or any similar term, as used herein, may mean a human or non-human (e.g., computer-based) user thereof. Moreover, “user”, or any similar term, as used herein is contemplated to mean users at any stage of a usage process.

References to “person”, “individual”, “human”, “a party”, or any similar term, as used herein, it should be understood that such references are sole by way of example

Headings provided are for convenience and are not to be taken as limiting the present disclosure in any way.

Each term utilized herein is to be given its broadest interpretation given the context in which that term is utilized.

### Terminology

The following paragraphs provide context for terms found in the present disclosure (including the claims):

The transitional term “comprising”, which is synonymous with “including,” “containing,” or “characterized by,” is inclusive or open-ended and does not exclude additional, unrecited elements or method steps. See, e.g., Mars Inc. v. H.J. Heinz Co., 377 F.3d 1369, 1376, 71 USPQ2d 1837, 1843 (Fed. Cir. 2004) (“[L]ike the term ‘comprising,’ the terms ‘containing’ and ‘mixture’ are open-ended.”). “Configured to” or “operable for” is used to connote structure by indicating that the mechanisms/units/circuits/components include structure that performs the task or tasks during operation. “Configured to” may include adapting a manufacturing process to fabricate components that are adapted to implement or perform one or more tasks.

“Based On.” As used herein, this term is used to describe factors that affect a determination without otherwise precluding other or additional factors that may affect that determination. More particularly, such a determination may be solely “based on” those factors or based, at least in part, on those factors.

All terms of example language (e.g., including, without limitation, “such as”, “like”, “for example”, “for instance”, “similar to”, etc.) are not exclusive of other examples and therefore mean “by way of example, and not limitation . . . ”.

A description of an embodiment having components in communication with each other does not infer that all enumerated components are needed.

A commercial implementation in accordance with the scope and spirit of the present disclosure may be configured according to the needs of the particular application, whereby any function(s of the teachings related to any described embodiment of the present invention may be suitably changed by those skilled in the art.

A “computer” may refer to a machine that can be instructed to carry out sequences of arithmetic or logical operations automatically via computer programming. Modern computers have the ability to follow generalized sets of operations, called programs. These programs enable computers to perform an extremely wide range of tasks. A “complete” computer including the hardware, the operating system (main software), and peripheral equipment required and used for “full” operation can be referred to as a computer system. This term may as well be used for a group of computers that are connected and work together, in particular a computer network or computer cluster. Computers are used as control systems for a wide variety of industrial and consumer devices.

Those of skill in the art will appreciate that some embodiments of the disclosure may be practiced in network computing environments with many types of computer system configurations, including hand-held devices programmable consumer electronics. Where appropriate, embodiments may also be practiced in distributed computing environments where tasks may be completed by local and remote processing devices.

“Software” may refer to a collection of data or computer instructions that tell the computer how to work. This is in contrast to physical hardware, from which the system is built and actually performs the work. In computer science and software engineering, computer software is all information processed by computer systems, programs and data. Computer software includes computer programs, libraries and related non-executable data, such as online documentation or digital media. Computer hardware and software require each other and neither can be realistically used on its own.

The example embodiments described herein can be implemented in an operating environment comprising computer-executable instructions (e.g., software) installed on a computer, in hardware, or in a combination of software and hardware. The computer-executable instructions can be written in a computer programming language or can be embodied in firmware logic.

A “computer network” refers to a digital telecommunications network which allows nodes to share resources. In computer networks, computing devices exchange data with each other using connections (data links) between nodes. These data links are established over cable media such as wires or optic cables, or wireless media such as Wi-Fi. Network computer devices that originate, route and terminate the data are called network nodes. Nodes are generally identified by network addresses, and can include hosts such as personal computers, phones, and servers, as well as networking hardware such as routers and switches. Two such devices can be said to be networked together when one device is able to exchange information with the other device, whether or not they have a direct connection to each other.

Computer networks differ in the transmission medium used to carry their signals, communications protocols to organize network traffic, the network's size, topology, traffic control mechanism and organizational intent. The best-known computer network is the Internet, which is the global system of interconnected computer networks that use the Internet protocol suite (TCP/IP) to link devices worldwide. It is a network of networks that includes private, public, academic, business, and government networks of local to global scope, linked by a broad array of electronic, wireless, and optical networking technologies.

Aspects of the present invention are described below with reference to flowchart illustrations and/or block diagrams of methods, apparatus (systems) and computer program products according to the disclosed embodiments. Each block of the flowchart illustrations and/or block diagrams, and combinations of blocks in the flowchart illustrations and/or block diagrams, can be implemented by computer program instructions.

The flowchart and block diagrams in the figures illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical function(s). Functions noted in the block may occur out of the order noted in the figures. For example, two blocks shown in succession may, in fact, be executed substantially concurrently, or the blocks may sometimes be executed in the reverse order, depending upon the functionality involved.

Further, any sequence of steps that may be described does not necessarily indicate a condition that the steps be performed in that order. Some steps may be performed simultaneously.

The functionality and/or the features of a particular component may be alternatively embodied by one or more other devices which are not explicitly described as having such functionality/features. Also, various embodiments of the present invention need not include a device itself.

The term “computer-readable medium” as used herein refers to any medium is involved in providing data (e.g., instructions) which may be read by a computer, a processor or a like device. Such a medium may take many forms, including but not limited to, non-volatile media, volatile media, and transmission media.

Non-volatile memory (NVM) or non-volatile storage is a type of computer memory that can retrieve stored information even after having been power cycled. In contrast, volatile memory needs constant power in order to retain data. Examples of non-volatile memory include read-only memory, flash memory, ferroelectric RAM, most types of magnetic computer storage devices (e.g. hard disk drives, solid state drives, floppy disks, and magnetic tape), optical discs, and early computer storage methods such as paper tape and punched cards.

Non-volatile memory can be classified as traditional non-volatile disk storage, or storage in non-volatile memory chips (Flash memory Storage)—EEPROM, SSD, NAND, etc. Volatile memory, in contrast to non-volatile memory, is computer memory that requires power to maintain the stored information; it retains its contents while powered on but when the power is interrupted, the stored data is quickly lost.

Volatile memory has several uses including as primary storage. In addition to usually being faster than forms of mass storage such as a hard disk drive, volatility can protect sensitive information, as it becomes unavailable on power-down. Most of the general-purpose random-access memory (RAM) is volatile.

A transmission medium is something that can mediate the propagation of signals for the purposes of telecommunication. Signals are typically imposed on a wave of some kind suitable for the chosen medium. Vacuum or air constitutes a good transmission medium for electromagnetic waves such as light and radio waves. While material substance is not required for electromagnetic waves to propagate, such waves may be affected by the transmission media they pass through, for instance by absorption or by reflection or refraction at the interfaces between media. Technical devices can therefore be employed to transmit or guide waves. Thus, an optical fiber or a copper cable are used as transmission media.

Electromagnetic radiation can be transmitted through an optical medium, such as optical fiber, or through twisted pair wires, coaxial cable, or dielectric-slab waveguides. It may also pass through any physical material that is transparent to the specific wavelength, such as water, air, glass, or concrete.

Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols, such as Bluetooth, TDMA, CDMA, 3G.

Where databases are described, it will be understood by those of ordinary skill in the art that: (i) database structures alternative to those described may be implemented, (ii) other memory structures other than databases may be implemented. Any schematic illustrations and accompanying descriptions of any sample databases presented herein are example arrangements for stored representations of information.

As used herein, “client-side” refers to operations that are performed by the client in a client-server relationship in a computer network. Typically, a client is a computer application, such as a web browser, that runs on a user's local computer, smartphone, or other device, and connects to a server as necessary. Operations may be performed client-side because they require access to information or functionality that is available on the client but not on the server, because the user needs to observe the operations or provide input, or because the server lacks the processing power to perform the operations in a timely manner for all of the clients it serves.

When the server serves data in a commonly used manner, for example according to standard protocols such as HTTP or FTP, users may have their choice of a number of client programs (e.g. most modern web browsers can request and receive data using HTTP and FTP). In the case of more specialized applications, programmers may write their own server, client, and communications protocol which can only be used with one another.

Programs that run on a user's local computer without ever sending or receiving data over a network are not considered clients, and so the operations of such programs would not be termed client-side operations.

Example networks may operate with any of a number of protocols, such as Internet protocol (IP), asynchronous transfer mode (ATM), and/or synchronous optical network (SONET), user datagram protocol (UDP), IEEE 802.x, etc.

Embodiments of the invention may also be implemented in one or a combination of hardware, firmware, and software. They may be implemented as instructions stored on a machine-readable medium, which may be read and executed by a computing platform to perform the operations described herein.

More specifically, as will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

An “algorithm” as referred to herein implies, in computer systems, an instance of logic written in software by software developers, to be effective for the intended “target” computer(s) to produce output from given (perhaps null) input. An optimal algorithm, even running in outdated hardware, may produce faster results than a non-optimal (higher time complexity) algorithm for the same purpose, running in more efficient hardware; that is why algorithms, like computer hardware, are considered technology.

Unless specifically stated otherwise, and as may be apparent from the following description and claims, it should be appreciated that throughout the specification descriptions utilizing terms such as “processing,” “computing,” “calculating,” “determining,” or the like, refer to the action and/or processes of a computer or computing system that manipulate and/or transform data represented as physical, such as electronic, quantities within the computing system's registers and/or memories.

Additionally, the phrase “configured to” or “operable for” can include generic structure (e.g., generic circuitry) that is manipulated by software and/or firmware to operate in a manner that is capable of performing the task(s) at issue. “Configured to” may also include adapting a manufacturing process to fabricate devices that are adapted to perform one or more tasks.

In a similar manner, the term “processor” may refer an electronic circuit which performs operations on some external data source, usually memory or some other data stream. The term is frequently used to refer to the central processor (central processing unit) in a system, but typical computer systems (especially SoCs) combine a number of specialized “processors”. Embodiments within the scope of the present disclosure may also include tangible and/or non-transitory computer-readable storage media for carrying or having computer-executable instructions or data structures stored thereon. By way of example, and not limitation, such non-transitory computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design.

A non-transitory computer readable medium includes, but is not limited to: a hard drive, compact disc, flash memory, volatile memory, random access memory, magnetic memory, optical memory, semiconductor-based memory, phase change memory, optical memory, periodically refreshed memory, and the like.

### Definitions

The following terms and phrases, unless otherwise indicated, shall be understood to have the following meanings.

The term “task” implies a piece of work to be done or undertaken.

The term “housework” implies regular work done in housekeeping, such as cleaning, shopping, and cooking.

The term “renovation” implies process of improving a broken, damaged, or outdated structure. Renovations are typically either commercial or residential. Additionally, renovation can refer to making something new, or bringing something back to life and can apply in social contexts.

The term “remodel” implies a change the structure or form of (something, especially a building).

The term “cabinet” implies a box-shaped piece of furniture with doors and/or drawers for storing miscellaneous items. Some cabinets stand-alone while others are built in to a wall or are attached to it like a medicine cabinet. Cabinets are typically made of wood (solid or with veneers or artificial surfaces), coated steel (common for medicine cabinets), or synthetic materials. Commercial grade cabinets, which differ in the materials used, are called casework, casegoods, or case furniture. Cabinets usually have one or more doors on the front, which are mounted with door hardware, and occasionally a lock. Cabinets may have one or more doors, drawers, and/or shelves. Short cabinets often have a finished surface on top that can be used for display, or as a working surface, such as the countertops found in kitchens. A cabinet intended to be used in a bedroom and with several drawers typically placed one above another in one or more columns intended for clothing and small articles is called a chest of drawers. A small bedside cabinet is more frequently called a nightstand or night table. A tall cabinet intended for clothing storage including hanging of clothes is called a wardrobe or an armoire, or (in some countries) a closet if built-in.

The term “carpentry” implies a is a skilled trade and a craft in which the primary work performed is the cutting, shaping and installation of building materials during the construction of buildings, ships, timber bridges, concrete formwork, etc. Carpenters traditionally worked with natural wood and did the rougher work such as framing, but today many other materials are also used [source: Roza, Greg. A career as a carpenter; New York: Rosen Pub., 2011; 6; Print] and sometimes the finer trades of cabinetmaking and furniture building are considered carpentry.

The term “carpet” implies a textile floor covering typically consisting of an upper layer of pile attached to a backing. The pile was traditionally made from wool, but, since the 20th century, synthetic fibers such as polypropylene, nylon or polyester are often used, as these fibers are less expensive than wool. The pile usually consists of twisted tufts which are typically heat-treated to maintain their structure. The term “carpet” is often used interchangeably with the term “rug”, although the term “carpet” can be applied to a floor covering that covers an entire house, whereas a “rug” is generally no bigger than a single room, and traditionally does not even span from one wall to another, and is typically not even attached as part of the floor. Carpets are used for a variety of purposes, including insulating a person's feet from a cold tile or concrete floor, making a room more comfortable as a place to sit on the floor (e.g., when playing with children or as a prayer rug), reducing sound from walking (particularly in apartment buildings) and adding decoration or color to a room. Carpets can be made in any color by using differently dyed fibers. Carpets can have many different types of patterns and motifs used to decorate the surface. In the 2000s, carpets are used in industrial and commercial establishments such as retail stores and hotels and in private homes. In the 2010s, a huge range of carpets and rugs are available at many price and quality levels, ranging from inexpensive, synthetic carpets that are mass-produced in factories and used in commercial buildings to costly hand-knotted wool rugs which are used in private homes of wealthy families. Carpets can be produced on a loom quite similar to woven fabric, made using needle felts, knotted by hand (in oriental rugs), made with their pile injected into a backing material (called tufting), flatwoven, made by hooking wool or cotton through the meshes of a sturdy fabric or embroidered. Carpet is commonly made in widths of 12 feet (3.7 m) and 15 feet (4.6 m) in the US, 4 m and 5 m in Europe. Since the 19th and 20th century, where necessary for wall-to-wall carpet, different widths of carpet can be seamed together with a seaming iron and seam tape (formerly it was sewn together) and fixed to a floor over a cushioned underlay (pad) using nails, tack strips (known in the UK as gripper rods), adhesives, or occasionally decorative metal stair rods. Wall-to-wall carpet is distinguished from rugs or mats, which are loose-laid floor coverings, as wall-to-wall carpet is fixed to the floor and covers a much larger area.

The term “chimney” implies an architectural ventilation structure made of masonry, clay or metal that isolates hot toxic exhaust gases or smoke produced by a boiler, stove, furnace, incinerator or fireplace from human living areas. Chimneys are typically vertical, or as near as possible to vertical, to ensure that the gases flow smoothly, drawing air into the combustion in what is known as the stack, or chimney effect. The space inside a chimney is called the flue. Chimneys are adjacent to large industrial refineries, fossil fuel combustion facilities or part of buildings, steam locomotives and ships.

The term “fireplace” implies a structure made of brick, stone or metal designed to contain a fire. Fireplaces are used for the relaxing ambiance they create and for heating a room. Modern fireplaces vary in heat efficiency, depending on the design. Historically they were used for heating a dwelling, cooking, and heating water for laundry and domestic uses. A fire is contained in a firebox or firepit; a chimney or other flue allows exhaust to escape. A fireplace may have the following: a foundation, a hearth, a firebox, a mantelpiece; a chimney crane (used in kitchen and laundry fireplaces), a grate, a lintel, a lintel bar, home over-mantel, a damper, a smoke chamber, a throat, a flue, and a chimney filter or afterburner [source: http://www.biopress.dk/PDF/FiB%20nr.%2021-2007_05%20-%20UK.pdf; retrieved on Jul. 11, 2019]. On the exterior there is often a corbeled brick crown, in which the projecting courses of brick act as a drip course to keep rainwater from running down the exterior walls. A cap, hood, or shroud serves to keep rainwater out of the exterior of the chimney; rain in the chimney is a much greater problem in chimneys lined with impervious flue tiles or metal liners than with the traditional masonry chimney, which soaks up all but the most violent rain. Some chimneys have a spark arrestor incorporated into the crown or cap.

The term “deck” implies a flat surface capable of supporting weight, similar to a floor, but typically constructed outdoors, often elevated from the ground, and usually connected to a building. The term is a generalization of decks as found on ships. Wood or timber “decking” can be used in a number of ways: as part of garden landscaping, to extend living areas of houses, and as an alternative to stone based features such as patios. Decks are made from treated lumber, composite lumber, composite material, and Aluminum. Lumber may be Western red cedar, teak, mahogany, ipê and other hardwoods. Recycled planks may be high-density polyethylene (HDPE), polystyrene (PS) and PET plastic as well as mixed plastics and wood fiber (often called “composite” lumber). Artificial decking products are often called “wood-plastic composites”. These days, WPC's have more widely known by different brands like NewTechWood, Azek, Ecornboard etc.

The term “garage door” implies a large door on a garage that opens either manually or by an electric motor (a garage door opener). Garage doors are frequently large enough to accommodate automobiles and other vehicles. Small garage doors may be made in a single panel that tilts up and back across the garage ceiling. Larger doors are usually made in several jointed panels that roll up on tracks across the garage ceiling, or into a roll above the doorway. The operating mechanism is spring-loaded or counterbalanced to offset the weight of the door and reduce human or motor effort required to operate the door. Less commonly, some garage doors slide or swing horizontally. Doors are made of wood, metal, or fiberglass, and may be insulated to prevent heat loss. Warehouses, bus garages and locomotive sheds have larger versions.

The term “drywall” (also referred to as plasterboard, wallboard, sheet rock, gyprock, gypsum board, or gypsum panel) implies panel made of calcium sulfate dihydrate (gypsum), with or without additives, typically extruded between thick sheets of facer and backer paper, used in the construction of interior walls and ceilings.[source: “Definition of PLASTERBOARD”. www.merriam-webster.com. Archived from the original on 2015 Feb. 18.] The plaster is mixed with fiber (typically paper, fiberglass, asbestos, or a combination of these materials), plasticizer, foaming agent, and various additives that can reduce mildew, flammability, and water absorption.

The term “electrician” implies a tradesman specializing in electrical wiring of buildings, transmission lines, stationary machines, and related equipment. Electricians may be employed in the installation of new electrical components or the maintenance and repair of existing electrical infrastructure. [Source: Roger Jones (2004). Electrician. Trotman Publishing. ISBN 0-85660-997-8.] Electricians may also specialize in wiring ships, airplanes, and other mobile platforms, as well as data and cable lines.

The term “fence” implies a structure that encloses an area, typically outdoors, and is usually constructed from posts that are connected by boards, wire, rails or netting. [Source: Patrick Hanks, ed. (1985). Collins Dictionary of the English Language. William Collins Sons & Co. Ltd. p. 534. ISBN 0-00-433078-1.] A fence differs from a wall in not having a solid foundation along its whole length. [Source: Dr D G Hessayon (1992). The Garden DIY Expert. pbi publications. p. 5. ISBN 0-903505-37-1.]

The term “natural gas” implies a naturally occurring hydrocarbon gas mixture consisting primarily of methane, but commonly including varying amounts of other higher alkanes, and sometimes a small percentage of carbon dioxide, nitrogen, hydrogen sulfide, or helium. [Source: “Background”. Naturalgas.org. Archived from the original on 9 Jul. 2014. Retrieved 14 Jul. 2012.] It is formed when layers of decomposing plant and animal matter are exposed to intense heat and pressure under the surface of the Earth over millions of years. The energy that the plants originally obtained from the sun is stored in the form of chemical bonds in the gas. [Source: “Electricity from Natural Gas”. Archived from the original on 6 Jun. 2014. Retrieved 10 Nov. 2013.] Natural gas is a non-renewable hydrocarbon used as a source of energy for heating, cooking, and electricity generation. It is also used as a fuel for vehicles and as a chemical feedstock in the manufacture of plastics and other commercially important organic chemicals. Natural gas is often informally referred to simply as “gas”, especially when compared to other energy sources such as oil or coal. However, it is not to be confused with gasoline, especially in North America, where the term gasoline is often shortened in colloquial usage to gas.

The term “rain gutter” (also referred to as an eavestrough or surface water collection channel) implies a component of water discharge system for a building. Gutters prevent water ingress into the fabric of the building by channeling the rainwater away from the exterior of the walls and their foundations. Water running down the walls causes dampness in the affected rooms and provides a favorable environment for growth of mold, and wet rot in timber.

The term “heating, ventilation, and air conditioning (“HVAC”)” implies the technology of indoor and vehicular environmental comfort. [Source: “HVAC”. Merriam-Webster Dictionary]. Its goal is to provide thermal comfort and acceptable indoor air quality. HVAC system design is a subdiscipline of mechanical engineering, based on the principles of thermodynamics, fluid mechanics and heat transfer. “Refrigeration” is sometimes added to the field's abbreviation, as HVAC&R or HVACR or “ventilation” is dropped, as in HACR (as in the designation of HACR-rated circuit breakers). HVAC is a part of residential structures such as single family homes, apartment buildings, hotels and senior living facilities, medium to large industrial and office buildings such as skyscrapers and hospitals, vehicles such as cars, trains, airplanes, ships and submarines, and in marine environments, where safe and healthy building conditions are regulated with respect to temperature and humidity, using fresh air from outdoors. Ventilating or ventilation (the V in HVAC) is the process of exchanging or replacing air in any space to provide high indoor air quality which involves temperature control, oxygen replenishment, and removal of moisture, odors, smoke, heat, dust, airborne bacteria, carbon dioxide, and other gases. Ventilation removes unpleasant smells and excessive moisture, introduces outside air, keeps interior building air circulating, and prevents stagnation of the interior air. Ventilation includes the exchange of air to the outside as well as circulation of air within the building. It is one of the most important factors for maintaining acceptable indoor air quality in buildings. Methods for ventilating a building may be divided into mechanical/forced and natural types. [Source: Ventilation and Infiltration chapter, Fundamentals volume of the ASHRAE Handbook, ASHRAE, Inc., Atlanta, Ga., 2005].

The term “lighting” implies the deliberate use of light to achieve a practical or aesthetic effect. Lighting includes the use of artificial light sources like lamps and light fixtures, as well as natural illumination by capturing daylight. Daylighting (using windows, skylights, or light shelves) is sometimes used as the main source of light during daytime in buildings. This can save energy in place of using artificial lighting, which represents a major component of energy consumption in buildings. Proper lighting can enhance task performance, improve the appearance of an area, or have positive psychological effects on occupants. Indoor lighting is usually accomplished using light fixtures, and is a key part of interior design. Lighting can also be an intrinsic component of landscape projects.

The term “tap” (also referred to as a spigot or a faucet) implies a valve controlling the release of a liquid or gas. Water for baths, sinks and basins can be provided by separate hot and cold taps; this arrangement is common in older installations, particularly in public washrooms/lavatories and utility rooms/laundries. In kitchens and bathrooms, mixer taps are commonly used. In this case, hot and cold water from the two valves is mixed before reaching the outlet, allowing the water to emerge at any temperature between that of the hot and cold water supplies. For baths and showers, mixer taps frequently incorporate some sort of pressure balancing feature so that the hot/cold mixture ratio will not be affected by transient changes in the pressure of one or other of the supplies. This helps avoid scalding or uncomfortable chilling as other water loads occur (such as the flushing of a toilet). Rather than two separate valves, mixer taps frequently use a single, more complex, valve controlled by a single handle (single handle mixer). The handle moves up and down to control the amount of water flow and from side to side to control the temperature of the water. A gas tap is a specific form of ball valve used in residential, commercial, and laboratory applications for coarse control of the release of fuel gases (such as natural gas, coal gas, and syngas). Like all ball valves its handle will parallel the gas line when open and be perpendicular when closed, making for easy visual identification of its status.

The term “leak” implies a way (usually an opening) for fluid to escape a container or fluid-containing system, such as a tank or a ship's hull, through which the contents of the container can escape or outside matter can enter the container. Leaks are usually unintended and therefore undesired. The word leak usually refers to a gradual loss; a sudden loss is usually called a spill. The matter leaking in or out can be gas, liquid, a highly viscous paste, or even a solid such as a powdered or granular solid or other solid particles. Sometimes the word “leak” is used in a figurative sense. For example, in a news leak secret information becomes public. According to ASTM D7053-17, water leakage is the passage of (liquid) water through a material or system designed to prevent passage of water. Types of leak openings include a puncture, gash, rust or other corrosion hole, very tiny pinhole leak (possibly in imperfect welds), crack or microcrack, or inadequate sealing between components or parts joined together. When there is a puncture, the size and shape of the leak can often be seen, but in many other cases, the size and shape of the leak opening may not be so obvious. In many cases, the location of a leak can be determined by seeing material drip out at a certain place, although the leak opening itself is not obvious. In some cases, it may be known or suspected there is a leak, but even the location of the leak is not known. Since leak openings are often so irregular, leaks are sometimes sized by the leakage rate, as in volume of fluid leaked per time, rather than the size of the opening.

The term “locksmithing” implies the science and art of making and defeating locks. A lock is a mechanism that secures buildings, rooms, cabinets, objects, or other storage facilities. A “smith” of any type is one who shapes metal pieces, often using a forge or mold, into useful objects or to be part of a more complex structure. Locksmithing, as its name implies, is the assembly and designing of locks and their respective keys.

The term “wood flooring” implies any product manufactured from timber that is designed for use as flooring, either structural or aesthetic. Wood is a common choice as a flooring material and can come in various styles, colors, cuts, and species. Bamboo flooring is often considered a form of wood flooring, although it is made from a grass (bamboo) rather than a timber.

The term “masonry” implies the building of structures from individual units, which are often laid in and bound together by mortar; the term masonry can also refer to the units themselves. The common materials of masonry construction are brick, building stone such as marble, granite, and limestone, cast stone, concrete block, glass block, and adobe. Masonry is generally a highly durable form of construction. However, the materials used, the quality of the mortar and workmanship, and the pattern in which the units are assembled can substantially affect the durability of the overall masonry construction. A person who constructs masonry is called a mason or bricklayer. These are classified as construction trades.

The term “painting” implies the practice of applying paint, pigment, color or other medium [source: Paint—Definition”. Merriam-webster.com. 2012. Retrieved 13 Mar. 2014] to a solid surface (called the “matrix” or “support”). The medium is commonly applied to the base with a brush, but other implements, such as knives, sponges, and airbrushes, can be used. The final work is also called a painting.

The term “plumbing” implies any system that conveys fluids for a wide range of applications. Plumbing uses pipes, valves, plumbing fixtures, tanks, and other apparatuses to convey fluids. [Source: Muscroft, Steve (Mar. 14, 2016). Plumbing. Elsevier. p. 3.] Heating and cooling (HVAC), waste removal, and potable water delivery are among the most common uses for plumbing, but it is not limited to these applications. [Source: Blankenbaker, Keith. Modern Plumbing. Goodheart Willcox.]

The term “roof” implies the top covering of a building, including all materials and constructions necessary to support it on the walls of the building or on uprights; it provides protection against rain, snow, sunlight, extremes of temperature, and wind. [Source: Harris, Cyril M. (editor). Dictionary of Architecture and Construction, Third Edition, New York, McGraw Hill, 2000, p. 775] A roof is part of the building envelope. The characteristics of a roof are dependent upon the purpose of the building that it covers, the available roofing materials and the local traditions of construction and wider concepts of architectural design and practice and may also be governed by local or national legislation. In most countries a roof protects primarily against rain. A verandah may be roofed with material that protects against sunlight but admits the other elements. The roof of a garden conservatory protects plants from cold, wind, and rain, but admits light. A roof may also provide additional living space, for example a roof garden.

The term “sanitary sewer or foul sewer” implies an underground pipe or tunnel system for transporting sewage from houses and commercial buildings (but not stormwater) to treatment facilities or disposal. Sanitary sewers are part of an overall system called a sewage system or sewerage. Sewage may be treated to control water pollution before discharge to surface waters. [Source: Metcalf, Leonard; Eddy, Harrison P. (1922). Sewerage and Sewage Disposal: A Textbook. New York: McGraw-Hill; Staley, Cady; Pierson, George S. (1899). The Separate System of Sewerage, Its Theory and Construction. New York: Van Nostrand.] Sanitary sewers serving industrial areas also carry industrial wastewater. Separate sanitary sewer systems are designed to transport sewage alone. In municipalities served by sanitary sewers, separate storm drains may convey surface runoff directly to surface waters. Sanitary sewers are distinguished from combined sewers, which combine sewage with stormwater runoff in one pipe. Sanitary sewer systems are beneficial because they avoid combined sewer overflows.

The term “fire sprinkler system” implies an active fire protection method, consisting of a water supply system, providing adequate pressure and flowrate to a water distribution piping system, onto which fire sprinklers are connected. Although historically only used in factories and large commercial buildings, systems for homes and small buildings are now available at a cost-effective price. [Source: “Industrial Fire sprinklers”. Fire Safety Advice Centre. Archived from the original on 16 Jan. 2013. Retrieved 6 Feb. 2013.] Fire sprinkler systems are extensively used worldwide, with over 40 million sprinkler heads fitted each year. In buildings completely protected by fire sprinkler systems, over 96% of fires were controlled by fire sprinklers alone. [Source: Hall, John R. Jr. (June 2013). “US Experience with Sprinklers”. NFPA. Archived from the original on 12 Mar. 2016. Retrieved 15 Mar. 2016.]

The term “swimming pool, swimming bath, wading pool, or paddling pool” implies a structure designed to hold water to enable swimming or other leisure activities. Pools can be built into the ground (in-ground pools) or built above ground (as a freestanding construction or as part of a building or other larger structure), and are also a common feature aboard ocean-liners and cruise ships. In-ground pools are most commonly constructed from materials such as concrete, natural stone, metal, plastic, or fiberglass, and can be of a custom size and shape or built to a standardized size, the largest of which is the Olympic-size swimming pool. Many health clubs, fitness centers, and private clubs have pools used mostly for exercise or recreation. Many towns and cities provide public pools. Many hotels have pools available for their guests to use at their leisure. Educational facilities such as high schools and universities sometimes have pools for physical education classes, recreational activities, leisure, and competitive athletics such as swimming teams. Hot tubs and spas are pools filled with hot water, used for relaxation or hydrotherapy. They are common in hotels and health clubs, and can also be found in some homes. Special swimming pools are also used for diving, specialized water sports, and physical therapy, as well as for the training of lifeguards and astronauts. Swimming pools may be heated or unheated.

The term “tile” implies a thin object usually square or rectangular in shape. Tile is a manufactured piece of hard-wearing material such as ceramic, stone, metal, baked clay, or even glass, generally used for covering roofs, floors, walls, or other objects such as table-tops. Alternatively, tile can sometimes refer to similar units made from lightweight materials such as perlite, wood, and mineral wool, typically used for wall and ceiling applications. In another sense, a tile is a construction tile or similar object, such as rectangular counters used in playing games (see tile-based game). Tiles are often used to form wall and floor coverings, and can range from simple square tiles to complex or mosaics. Tiles are most often made of ceramic, typically glazed for internal uses and unglazed for roofing, but other materials are also commonly used, such as glass, cork, concrete and other composite materials, and stone. Tiling stone is typically marble, onyx, granite or slate. Thinner tiles can be used on walls than on floors, which require more durable surfaces that will resist impacts.

The term “wallpaper” implies material used in interior decoration to decorate the interior walls of domestic and public buildings. It is usually sold in rolls and is applied onto a wall using wallpaper paste. Wallpapers can come plain as “lining paper” (so that it can be painted or used to help cover uneven surfaces and minor wall defects thus giving a better surface), textured (such as Anaglypta), with a regular repeating pattern design, or, much less commonly today, with a single non-repeating large design carried over a set of sheets. The smallest rectangle that can be tiled to form the whole pattern is known as the pattern repeat. Wallpaper printing techniques include surface printing, gravure printing, silk screen-printing, rotary printing, and digital printing. Wallpaper is made in long rolls, which are hung vertically on a wall. Patterned wallpapers are designed so that the pattern “repeats”, and thus pieces cut from the same roll can be hung next to each other so as to continue the pattern without it being easy to see where the join between two pieces occurs. In the case of large complex patterns of images this is normally achieved by starting the second piece halfway into the length of the repeat, so that if the pattern going down the roll repeats after 24 inches, the next piece sideways is cut from the roll to begin 12 inches down the pattern from the first. The number of times the pattern repeats horizontally across a roll does not matter for this purpose. A single pattern can be issued in several different color-ways.

### Introduction

Advances in technology involving cellular data, global positioning service (“GPS”) based location capabilities, e.g., as may involve and/or be provided by geographically-aware components, and general smartphone and/or devices have resulted in the widespread adoption of rideshare services, inclusive of Uber® and/or Lyft®, where interested customers may merely input their desired pick-up and drop-off locations to have an independent contractor driver immediately drive over to their current physical location to pick them up and to proceed to drop them off at an intended destination. Known variations of the above generally described procedures include ride-pooling, referring to the concept of adding riders who are headed in the same direction to subsidize travel costs for the entire group. Such technology-based evolution has largely replaced entire industries, allowing working persons to commute to work using ride-sharing services and thus not individually own a vehicle, and further resulting in enhanced efficiency of vehicle usage, ensuring that vehicles are substantially used regularly until they are fully consumed, e.g., rendered inoperable, rather than having persons pay full price for a new car that merely sits and its used once or twice daily, etc. Such solutions have also alleviated traffic and congestion issues commonly facing megacities, such as (but not limited to): Los Angeles, San Francisco, Chicago, New York, Washington, D.C., and internationally, including Tokyo, Beijing, Shanghai, Seoul, Sydney and so on and so forth.

Smartphone-application based computer program solutions also extend to other technical fields and/or areas as well, including various outlets in the arts, entertainment, film, and other industries. Recently, a service known as TaskRabbit has emerged into prominence offering app-based scheduling of odd job assistance provided by skilled, semi-skilled, para-professionals and/or laborers who, in response to receiving a request from a customer, provide any number of services ranging from (but not limited to): handyman services, hauling, moving help, personal assistance (errands), minor home repairs, painting, yard clean-up and removal, delivery services, laundry services, IKEA® furniture assembly, TV mounting, hanging pictures, furniture delivery, light installation, closet organizing services, furniture removal, furniture movers, and furniture disassembly.

Typically access as an app installed on a smartphone, TaskRabbit receives user-inserted descriptive input regarding an intended task to be completed, e.g., the set-up of a home office and/or any related cable management associated therewith, to alert a number of nearby service providers, referred to as “taskers” who then provide the customer their hourly rates for that particular service. The customer may then select a particular service provider therefrom based on the rate and any feedback provided from previous customers in the form of ratings and/or actual descriptive feedback, etc.

Challenges prevalent in such an app include limitations regarding the type of services able to be requested for, e.g., limiting only to relatively non-technical assistance, creating difficulties for customers with specific needs best serviced by skilled, qualified, and/or certified technicians and/or engineers, e.g., electrical wiring replacement, installation of in-ground pools, expert renovations of pre-existing structures including wooden decks, and so on and so forth. Further, the procedure of manually typing out a description of the task requiring assistance can be lengthy, cumbersome, and error-prone, thus further complicating task-scheduling and completion efforts on part of the customer.

Current known methods and solutions, introduced below and incorporated herein by reference in their respective entireties, fail to adequately address the above-mentioned needs; and, instead, focus on addressing conventional ride-sharer transportation related needs and/or related correspondence over digital and/or wireless telecommunications networks.

U.S. Pat. No. 10,142,222 entitled “CUSTOMIZED COMMUNICATIONS FOR NETWORK SYSTEMS” issued on Nov. 27, 2018 relates to a network system that customizes communications and related channels for delivery to candidate providers registering with the network system. Candidate providers progress through steps of a network registration process by providing input data at the various steps. The network system provides communications to request the input data and facilitate the candidate providers' progress. The network system can use a machine learning model to predict particular types of communications and communication channels (e.g., online messages, phone calls, physical mail, etc.) that are likely to be well-received by candidate providers. Thus, the network system is able to increase the expected number of candidate providers that successfully register to provide services to other users of the network system.

U.S. Pat. No. 10,113,878 entitled “METHOD AND SYSTEM FOR SHARED TRANSPORT” issued on Oct. 30, 2018 relates to a transport arrangement system operates to provide a service, which can receive a transport pool request from a rider. The transport pool request can specify a set of parameters, including a pickup location and a drop-off location. A candidate set of transport providers are identified that satisfy one or more criterion, including a criterion of proximity relative to the pickup location. One of the candidate set of drivers is selected to provide a transport pool for the rider. The selection can be based at least in part on determining which individual drivers of the candidate set satisfy one or more constraints, including a first constraint that relate to a predicted trip completion time for the rider.

U.S. Pat. No. 10,078,337 entitled “GENERATION OF TRIP ESTIMATES USING REAL-TIME DATA AND HISTORICAL DATA” issued on Sep. 18, 2018 relates to a system uses machine models to estimate trip durations or distance. The system trains a historical model to estimate trip duration using characteristics of past trips. The system trains a real-time model to estimate trip duration using characteristics of recently completed trips. The historical and real-time models may use different time windows of training data to predict estimates, and may be trained to predict an adjustment to an initial trip estimate. A selector model is trained to predict whether the historical model, the real-time model, or a combination of the historical and real-time models will more accurately estimate a trip duration, given features associated with a trip duration request, and the system accordingly uses the models to estimate a trip duration. In some embodiments, the real-time model and the selector may be trained using batch machine learning techniques which allow the models to incorporate new trip data as trips complete.

U.S. Pat. No. 10,037,553 entitled “SELECTING VEHICLE TYPE FOR PROVIDING TRANSPORT” issued on Jul. 31, 2018 relates to a transport arrangement system operates to receive a transport request from a user, and to make a selection of a vehicle type for the user based at least in part on a set of criteria associated with the transport request or user information. For example, the determination of whether an autonomous vehicle is to be provided can be based at least in part on the destination specified with the transport request.

U.S. Pat. No. 7,315,832 entitled “ONLINE BIDDING SYSTEM” issued on Jan. 1, 2008 relates to an online auction system comprising a preliminary bidding portion and a virtual auction portion is disclosed herein. The preliminary bidding portion allows bidders to access auction items and input bids during a preestablished extended period of time. After the preliminary bidding portion concludes, the virtual auction portion provides bidders the opportunity to input bids on each item consecutively and individually from the preliminary auction portion in a manner similar to a conventional live auction. During the virtual auction portion, bidders are provided with a countdown to encourage further bidding before the previous bid becomes final. After each new bid is inputted, the countdown is reinitiated. The countdown is reinitiated until no new bids are input. An alert system notifies bidders that a particular item of interest is about to be offered for bid as part of the virtual auction portion. The system also provides bidders means for inputting proxy bids.

US Publication No.: 2015/0206093 entitled “CROWD SOURCED DELIVERY ASSISTANCE” published on Jul. 23, 2015 relates to crowd sourced delivery assistance. Receiving a submission comprising a geolocation and at least one of an image and an annotation. The received submission associated with a submitting courier. Publishing the received submission via a communications network accessible by a plurality of courier devices. Receiving a selection of a published submission. The selection associated with one of the plurality of courier devices. Transmitting the selected submission to the selecting courier device for display. Crediting a courier score of the submitting courier. If the consumer wants delivery of a locally stocked product within a short time frame, for example the same day as ordering, then the consumer is typically limited to delivery from a single business (for example pizza delivery and dry cleaning pick-up and delivery), or limited to delivery by a product category courier (for example, a multi-restaurant delivery service), or limited to delivery by a general courier, or limited to the use of errand labor auction service (for example, TaskRabbit™ online errand labor auction service).

US Publication No.: 2013/0132140 entitled “DETERMINING A LOCATION RELATED TO ON-DEMAND SERVICES THROUGH USE OF PORTABLE COMPUTING DEVICES” published on May 23, 2013 relates to a method for determining a location relating to an on-de-mand service on a computing device is provided. One or more processors receiving a transport request from a user. The transport request specifies at least one of a pick-up region or a drop-off region. One or more locations of interests within the at least one of the pick-up region or the drop-off region are determined. Based on the at least one of the pick-up region or the drop-off region, one or more historical locations related to the user is determined. A likely location is determined based on the determined one or more locations of interest and the one or more historical locations.

U.S. Pat. No. 9,230,292 entitled “PROVIDING ON-DEMAND SERVICES THROUGH USE OF PORTABLE COMPUTING DEVICES” published on Jan. 5, 2016 relates to a method for requesting an on-demand service on a computing device is provided. One or more processors determine the current location of the computing device. A multistate selection feature of a plurality of service options for providing the on-demand service is presented on the display of the computing device. The multi state selection feature enables a user to select a service option that is available within a region that includes the current location to provide the on-demand service. In response to the user selecting one of the plurality of service options, a summary user interface is presented on the display to provide region-specific information about the on-demand service based on the selected service option.

U.S. Pat. No. 9,135,353 entitled “HIGH PRECISION INTERNET LOCAL SEARCH” published on Sep. 15, 2015 relates to a high-precision local search that is performed on the Internet. A map image-rendering software provider embeds spatial keys into maps, which are then provided to producers of Internet content such as map providers. For example, a homeowner may post a message on a web bulletin board advertising his house for sale, and including a map showing the location of the house. When a search engine's web crawler encounters a page having a spatial key embedded in an image, the spatial key is indexed with the other content on the page. Because the spatial key identifies a small geographic area, indexing the content with the spatial key allows search queries to be limited by area and still provide useful results. Thus, a user of a search engine searching for “house for sale” in a specific area will be directed to web pages that meet the geographic and content search terms.

U.S. Pat. No. 9,482,549 entitled “DETERMINING LOCATION INFORMATION USING A LOCATION DATA POINT PROVIDED BY A COMPUTING DEVICE” issued on Nov. 1, 2016 relates to a system and method for determining location information using a location data point provided by a computing device. A location data point is received by a system from a client computing device. The system determines whether the location data point is within a predefined region from a plurality of predefined regions configured by a user of the system. If the location data point is within a predefined region, location information corresponding to the predefined region is transmitted to the client device. If the location data point is not within a predefined region, one or more third-party reverse geocoding services can be used that translates the location data point to a street address.

U.S. Pat. No. 10,119,827 entitled “PLANNING TRIPS ON A ROAD NETWORK USING TRACTION INFORMATION FOR THE ROAD NETWORK” issued on Nov. 6, 2018 relates to a computer system that maintains, for a given geographic region, a data structure that identifies a traction value for each of a plurality of locations of a road network within a geographic region. At least of a start or destination location is determined for the trip. The computer system may plan the trip, including selecting at least one of a route or a vehicle to use for the trip, based on the traction values of one or more of the plurality of locations.

U.S. Pat. No. 10,306,430 entitled “VEHICLE-TO-INFRASTRUCTURE COMMUNICATION” relates to a method that includes receiving a portion of a data offload from a radar antenna of a first vehicle. The data offload includes data packets that each include a sequence number and a total number of data packets in the data offload. The method includes generating a data packet log, storing in the data packet log the sequence number of each received data packet, determining that one or more sequence numbers are missing from the data packet log, and sending to the radar antenna, a communication signal that includes an acknowledgement and the sequence numbers that are missing from the data packet log. The method also includes determining that one or more data packets of the data offload include a location of an object in an environment surrounding the first vehicle, and sending the location of the object to a second radar antenna of a second vehicle.

The above-listed U.S. patents, U.S. patent application Publications, and non-patent literature are provided as examples are not intended to be limiting in any way. Although innovation in the smartphone-app based ride-share space appears rampant, and solutions geared towards providing service to particularized task requests may exist in some primitive form, no single solution exists permitting interested customers to rely on technology, e.g., artificial intelligence mated with human visual recognition, to immediately recognize a depicted task intended for completion to automatically communicate the same to qualified service providers within a defined geographic proximity of the customer. Some of the presently disclosed embodiments of this solution may at least partially involve advanced computer science related functionality and capabilities, whereas others may not, regardless of reliance on human and/or computer machine assisted detection of the tasks at hand, disclosed systems seamlessly communicate the needful to alert nearby service providers to tasks requested for completion by customers and also provide real-time tracking capabilities permitting for customers to observe selected service providers travel from an origin location to the destination of the job site.

At a high level of generality, the disclosed embodiments may be for a computer-based application, e.g., an “app”, referred to as “Fixense”, which may be related to systems and methods of use thereof for at least the following (but not limited thereto): (1) selection of a category of j ob completion (e.g., from dozens of available types of service jobs); (2) choice of location (of the customer) allowing for the customer to only be connected with local and/or nearby service providers; (3) describe the job by providing details such as uploading video or audio to show what needs to be done; and (4), confirmation and completion where the job description is send to nearby service providers who then review to provide bids; the customer may review the bids to select an appropriate person for the job. Common benefits of using “Fixense” may include (but are not limited to): (1) expediency and convenience (e.g., not requiring traditional lengthy user-driven searching, and not requiring extensive wait time for service request fulfilment; (2) ease-of-use (e.g., providing hassle-free booking of service providers through the app); and, (3) affiliation with trusted service providers (e.g., those who are pre-screened by the “Fixense” app management team and/or rated and reviewed by previous customers).

By way of example and not limitation, the “Fixense” app itself may be provided and/or electronically made available to interested customers for free, and real-time chat functionality may be made available allowing for customers to communicate with service providers directly during the task booking and completion process, if so desired by either the customer or the service provider. Potential disputes between a customer and a given service provider may be resolved via contact and/or communication with a “Fixense” app associated service team member available via phone. More specifically, by way of example and not limitation, in one or more embodiments, the Fixense app may not provide phone numbers of staff operational personnel, instead, all questions can be sent to Fixense via an electronic mail box provided in a Fixense-operated website and questions originating from service requestor apps will be responded to by Fixense personnel within a specified time period, such as 24 hours.

In some embodiments, sending of the job description to service providers may involve multiple hierarchical organizational intermediate steps, organizing service providers into preferred and general sub-categories, and selecting an optimal service provider from the preferred service providers for tracking to the job site location. Such organizational capabilities may at least partially consider geographic proximity of a given service provider and/or the price quoted by the service provider to the customer to complete the job, etc.

### System Structure

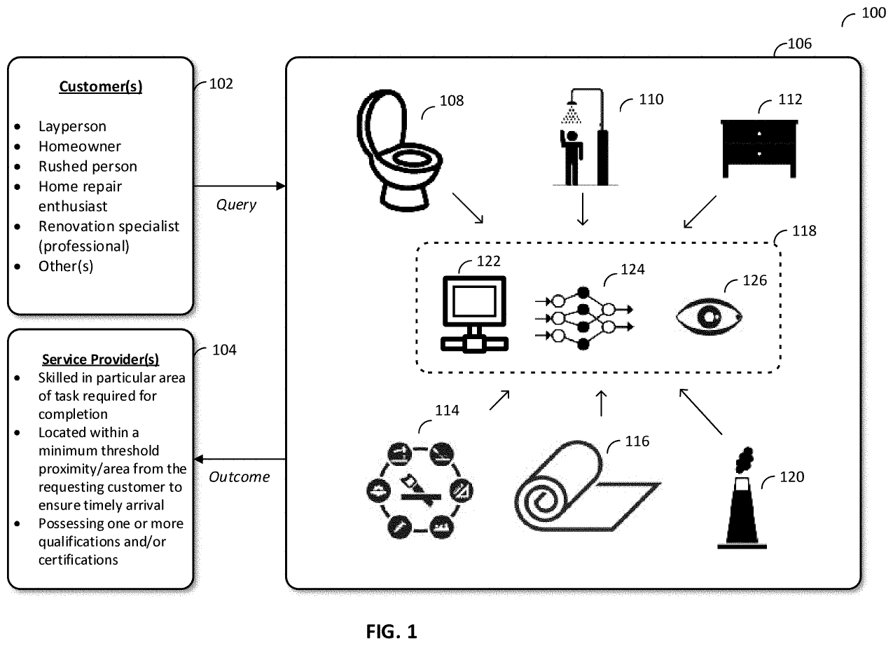

FIG. 1 illustrates an exemplary schematic diagram of a customer-initiated service request fulfilment system for various example tasks, in accordance with an embodiment of the presently disclosed embodiments. A system 100 is shown, e.g., “Fixense”, as associated with an on-demand smartphone and/or device installable application (an “app”), is intended to connect customers 102 with a database of local service providers 106 located within a defined geographic proximity to the customer 102 making a particular job completion request. All service providers in the database of local service providers 106 may be pre-screened by third-party resources associated with the ownership and/or management of the “Fixense” app, and also may be eligible to be rated and/or reviewed (in writing) by customers.

Such a pre-screening process may include, by way of example (and not limitation) at least: the collection of government-mandated information from service providers including their respective photos, phone numbers, home/office addresses, drivers' license numbers, etc. The system 100 may be configured to require service providers to include at least one link from, for example: either Facebook® reviews, Yelp® reviews, or any other site or app where such service providers been reviewed by customers, the link being included and/or uploaded onto their respective profiles as associated with the system 100. Such a feature and capability may help customers in selecting optimal providers for their job posts from the onset of the project or task booking process as accomplished by the requester, e.g., customers 102. Other embodiments, by way of example and not limitation, may weight reviews originated by Fixense-specific customers more heavily, since such reviews are from actual customers who have hired and paid service providers.

Engagement of particular service providers selected from the database of service providers may at least be partially based on an availability status of the service provider and/or a per-job contractual agreement and may thus involve no long-term recurring obligations, essentially allowing for interested customers 102 to post a job if and when they need to get it done with no additional complications.

By way of example and not limitation, customers 102 may include any one or more selected from a group including: laypersons, homeowners, rushed persons, home repair enthusiasts, renovation specialists (e.g., professionals and/or otherwise), and so on and so forth. The broad spectrum of customer 102 types may essentially encompass any party and/or entity, real or virtual, seeking assistance with a particular enumerated task and/or job, e.g., not otherwise suitable for easy or successful completion without professional and/or para-professional assistance.

Via the “Fixense” app, the customer may touch a related touch-screen activated portion on his or her smartphone, for example (but not limitation thereto), to communicate an electronic query related to the selection of a particular service (as shown in FIG. 1) to the database of local service providers 106, which may include any one or more of at least (without limitation thereto): plumbers 108, shower replacement and/or maintenance 110, cabinetry 112, odd-jobs 114, carpet installation 116, and/or chimney maintenance 120.

Those skilled in the art will appreciate that the example functionality modules shown as a part of the database of local service providers 106 is an example only and not limiting. Other services selected for scheduling from the database of local service providers 106 may include, but are not limited to, at least the following areas: bathroom fixtures, bathroom remodels, cabinetry, carpentry, carpet, chimneys and fireplaces, decks, doors, drywall, electrical, fencing, garage doors, gas installation and repair, gutters, heating, ventilation, and cooling, indoor and outdoor lighting, kitchen fixtures, kitchen remodels, laminate flooring, leak detection and repair, locksmith services, masonry, painting, plumbing, roofing, sewers and drains, sprinklers, swimming pools, tile flooring, wallpaper, windows, and wood flooring. Still further, other services selected for scheduling from the database of local service providers 106 may include, but are not limited to, at least the following areas: air conditioners, barbeque grills, ceiling fans, clothes dryers, clothes washers, coffee makers, dishwashers, freezers, garbage disposals, heating systems, microwave ovens, ovens, refrigerators, sewing machines, stoves, toasters/toaster ovens, vacuums, wall mounted air conditioners, water coolers, and water heaters. Even further, other services selected for scheduling from the database of local service providers 106 may include, but are not limited to, at least the following areas: clean-outs, gardening, house cleaning, moving, snow removal, and tree service. Moreover, other services selected for scheduling from the database of local service providers 106 may include, but are not limited to, at least the following areas: audio-visual equipment, cell phones, desktop computers, laptops, modems/routers, tablets, televisions, and portable electronic devices.

The database of local service providers 106 may electronically receive notification of the task and/or job request as communicated via an input query to them as shown in FIG. 1 to correspondingly communicate recognition and understanding of the task at a virtual location 118, e.g., that may be “cloud”-based and/or otherwise at least partially executed on computer servers stored at a location off-site to the customers 102 and/or the database of local service providers 106. For example (but not limitation thereto), such recognition may at least partially involve computer-assisted functionality including artificial intelligence 122, neural networking 124, and/or machine learning 126 to automatically recognize the task requested by the customers 102 based on at least a partial visual or audial representation thereof.

That is, the customer 102 may record a brief video and/or audio (and/or take an image and/or provide a supplemental text-based write-up) description of the task requested, e.g., set-up and cable management and/or clean-up for a home office, for the virtual location 118 to employ any one or more of the functionality 122-126 to automatically discern, categorize, organize, and forward the task-related request to an appropriate corresponding skilled and suitable service provider from the database. In one or more embodiments substantially alternative to that described above, the categorization and forwarding process of task identification and separation may be performed visually and/or audially by qualified live humans at and/or associated with the virtual location 118 who manually input information permitting for selection of service providers 104 related to the task at hand, e.g., upon viewing customer 102 service requests, such humans may manually cross-reference the technical nature of the service request to identify and alert corresponding qualified service providers and/or may be involved in ranking such service providers relative to their individual suitability to provide the service as needed. Such service providers 104 may be, by way of example and not limitation, skilled in a particular area of task required for completion, location within a minimum proximity and/or area from the requesting customer to ensure timely arrival to a job and/or work site, and/or may posses one or more qualifications and/or certifications. Service providers 104 may include, but not be limited to: plumbers, electricians, welders, haulers, heavy lifters, technicians, mechanics, engineers and may or may not possess any one or more of any required and/or preferred licenses, certifications, qualifications, work-history records, and so on and so forth.

Regardless of how the task provider is selected, e.g., automatically by a computer employing advanced algorithms including any one or more of that described in 122-126, or by human interaction, the system 100 may be at least partially involved in, as executed on one or more computer processors and/or stored on non-transitory memory, communicating, over a network, a task-related request from the customer 102 to the database of local service providers 106.

The task-related request may specify a set of parameters, including a task completion location and a representation of the task related request, e.g., as may be provided by the customer 102 in the form of a visual and/or audio recording. The system 100 may then function to differentiate the one or more service providers based on distance from each service provider to the customer 102 while also, for example (but not limitation thereto), considering, by the virtual location 118 and/or the functionality 122-126 associated therewith the type of task requested by the customer 102. Further, the system 100 may aggregate a price quote from each service provider from the database of local service providers 106 with the distance from each service provider to the customer, related publicly-available ratings and reviews for that service provider, and, optionally, task type related data, etc., as well as other potentially identifying factors, as identified computationally and/or manually as substantially described above to generate a service provider score for that service provider.

The system 100 may then assist in the selection of, upon receiving corresponding input from the customer 102, an optimal service provider from the database of local service providers 106 according to its total service provider score, e.g., referring to an internal, app-specific calculative algorithm responsible for organizing multiple service providers in relation to their respective ability to perform the requested task at least partially based on the origination location of the service provider as well as a given service provider skill set or capability level, etc., to, in turn, display tracked movement of the optimal service provider from its initial start location to a task completion location to the customer 102. The system 100 may assist in the differentiation of the one or more service providers in the database of local service providers 106, which may further involve: (1) determining a trip completion time for each service provider to arrive at the task completion location; (2) determining one or more preferred service providers based on a hierarchical ranking of the trip completion times for each service provider (e.g., from the database of local service providers 106); and, (3) restricting the selection of an optimal service provider, by the requester, to the one or more preferred service providers.

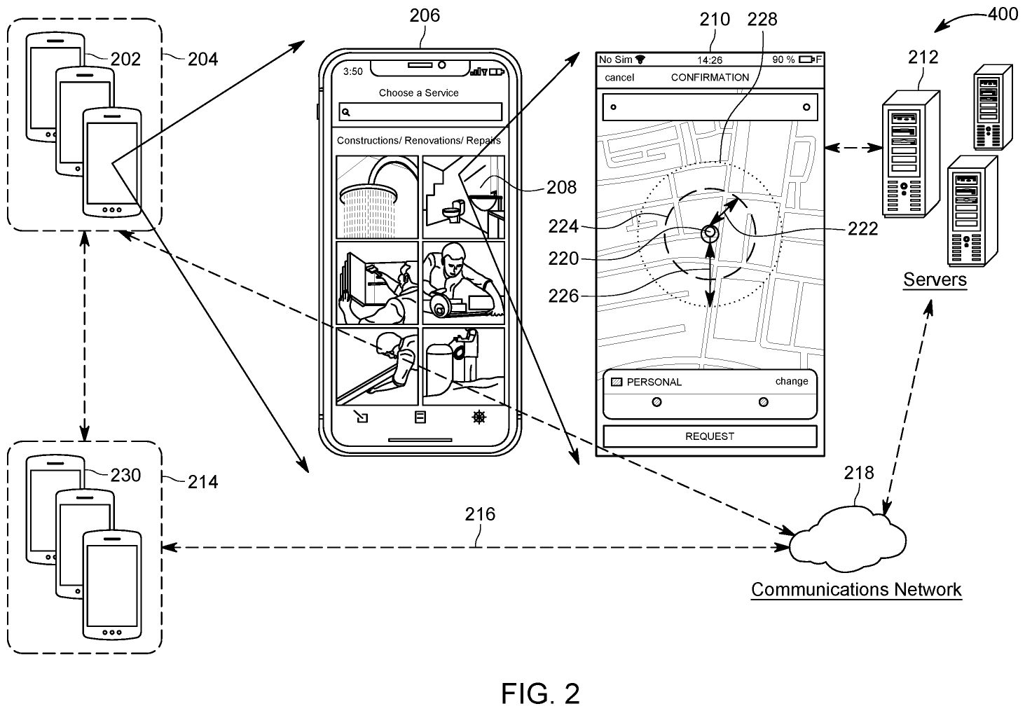

FIG. 2 illustrates an example “cloud”-based system for providing real-time geographic tracking data of a service provider traveling en route to a task completion location in response to a request placed by a customer, in accordance with an embodiment of the presently disclosed embodiments. Those skilled in the art will appreciate that customer-to-service provider system 200 may be substantially equivalent to the system 100 described in connection with FIG. 1 and/or may introduce new and/or different functionalities and/or capabilities without departing from the scope and spirit of the disclosed embodiments. In the present embodiment, a group 204 (e.g., of customer smartphones and/or devices) is shown in electronic and/or wireless communication, via the customer-to-service provider system 200, to a group of service provider smartphones and/or device 214.

Each the groups 204 and 214 may include multiple individual smartphones and/or devices 202, and 230, respectively, configured with each a customer-specific and service-provider specific versions of the “Fixense” app introduced earlier in FIG. 1. The customer-specific app installed on the customer smartphone and/or device 202 may feature a launch screen 206 permitting for the selection of a category of a particular job and/or task to be selected, e.g., bathroom fixtures, and so on and so forth. Subsequent to the successful selection of an intended task for completion 208, the “Fixense” app may proceed to a location confirmation entrance screen 210, which, in one or more embodiments, may at least partially rely on global positioning service (“GPS”) capabilities to accurately pin-point the exact or approximate physical geographic location of the customer as he or she (or they or it) makes a request for the completion of a particular service, e.g., the intended task for completion 208.

By way of example and not limitation, the location confirmation entrance screen 210 may have functionality and/or capabilities associated therewith regarding the setting of one or more radii indicative of relative proximity to the customer. Specifically, the customer may be located at a task completion location 220 from which an initial close proximity 224 may be drawn at an initial radius 222; likewise, further away at an extended radius 226 may be an extended proximity 228. Those skilled in the art will appreciate that the depictions of the initial close proximity 224 and the extended proximity 228 are provided as an example only and that the location confirmation entrance screen 210 of the customer-to-service provider system 200 may include greater or fewer radii with corresponding proximity circles drawn therefrom to define various thresholds within which service providers may be located, e.g., to also define, in one or more embodiments, a defined threshold maximum radius from which service providers may be contacted and/or selected. The location at which a service provider is present upon receiving a service request may be referred to as an “initial location”. Also, by way of example and not limitation, service providers located within the initial close proximity 224 may receive greater preference, e.g., in the form of a weightage, than service providers located within the extended proximity 228, and so on and so forth.

Therefore, the weightage given to a particular service provider (e.g., relative to the higher or lower ranking in a hierarchy of service providers provided to the customer, etc.) may be commensurate and/or proportionate to its respective geographic location relative to the customer at the task completion location 220, diminishing in strength and/or value upon moving further away therefrom. Those skilled in the art will appreciate that other configurations and/or programmatic arrangements may exist, e.g., such as those at least partially taking into account the topographies specific to the task completion location 220, such as those that may influence the arrival time of the task provider to the customer at the task completion location 220, or current traffic conditions, and so on and so forth.

Such information relative to the service provider's proximity to the customer is aggregated, parsed, and/or subject to any one or more suitable data manipulations to be stored at least partially on a communications network 218 (e.g., a centralized “cloud”-based database) that may at least be partially stored in one or more physical computer servers 212 to be at least partially executed and/or processed thereon. The communications network 218 may be in electronic communication with any one or more of the participants of the customer-to-service provider system 200, such as the group of service provider smartphones and/or device 214 via representative electronic communication passageway 216.

Service providers, by way of preference input and/or entry via their respective smartphones and/or devices 230, in one or more embodiments, may bid and/or otherwise provide price quote related information for each task requested by a customer via his, her, their, or its smartphones and/or device 202, upon successfully being notified of the task via the communications network 218. Thus, communications network 218 may be at least partially involved in linking customers to service providers and permitting service providers to place bids or price quotes on individual task requests that may be reviewed by customers prior to engagement of the service provider to fulfil the service. Such information may be considered in unison with the service providers relative distance from the customer as well as the service providers suitability to successfully complete the requested task at hand, all by the customer, prior to the customer making a final selection decision regarding an optimal service provider, etc.

Those skilled in the art will appreciate that the representations shown of the various systems, modules, devices, functionalities, instrumentalities, and/or capabilities associated with the customer-to-service provider system 200 are provided as an example only and that other suitable configurations and/or orientations, as well as additional and/or fewer modules and/or components, may exist without departing from the scope and spirit of the disclosed embodiments.

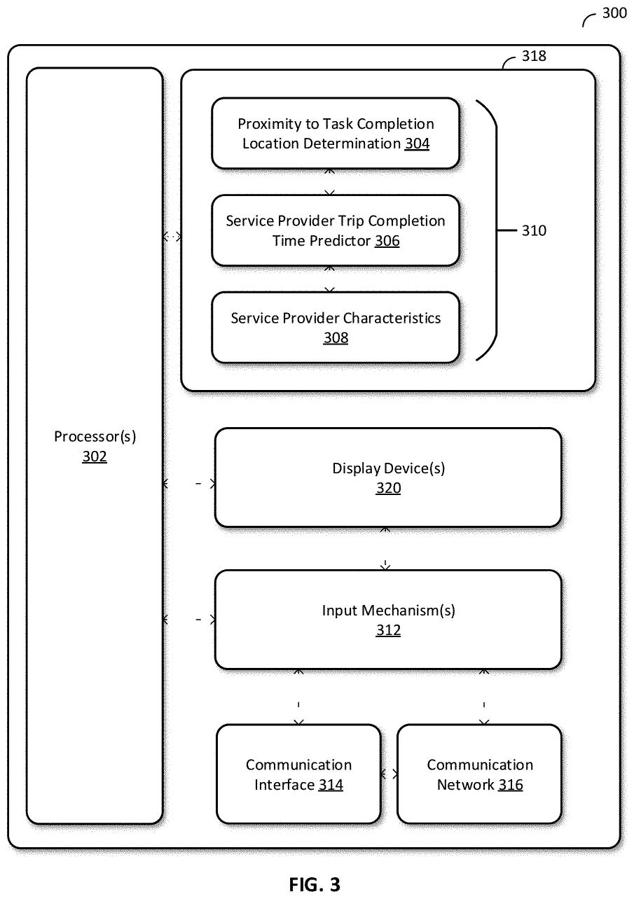

FIG. 3 illustrates an example arrangement of functional modules, at least partially executed in computer hardware, for the operation of a customer-initiated service request fulfilment system, in accordance with an embodiment of the presently disclosed embodiments. In the present embodiment, a computer-based system 300 is shown. Those skilled in the art will appreciate that the computer-based system 300 may be a manifestation and/or variant and/or equivalent and/or work in tandem with any one or more of the systems 100 and 200 shown and discussed earlier in connection with FIGS. 1 and 2, respectively. The computer-based system 300 may be at least partially implemented using a server (or combination of servers or other network computers). In one or more embodiments, the computer-based system 300 includes a processor 302, a memory 318, which can include a read-only memory (ROM) as well as a random access memory (RAM) or other dynamic storage device, a display device 320, an input mechanism 312 (e.g., describing generally how a human finger or thumb may contact a touch-sensitive surface of a smartphone to result in the transmission of corresponding electrical signals therefrom) and a communication interface 314 for communicative coupling to a communication network 316.

The processor 302 of the computer-based system 300 performs one or more processes, steps and other functions described with implementations such as described by any one or more of the FIGs. The processor 302 can process information and instructions stored in memory 318, such as provided by a random-access memory (RAM) or other dynamic storage device, for storing information and instructions which are executable by processor 302. The memory 318 can be used to store temporary variables or other intermediate information during execution of any one or more of functions 310 (e.g., as related to task selection and completion characterization). The memory 318 may include ROM or other static storage device for storing static information and instructions for processor 302. The communication interface 314 may operate to enable the computer-based system 300 to communicate with one or more communication networks (e.g., cellular network) through use of a network link (wireless or wired). Using the network link, the computer-based system 300 can communicate with one or more computing devices.

By way of example and not limitation, customers requesting the completion of tasks may communicate with, via the input mechanism 312, computer-based system 300 such that the functions 310 stored at least partially on and/or associated with memory 318 receive information. In an embodiment, information provided by service providers may similarly be forwarded to computer-based system 300 for at least partial storage in memory 318 for consideration by the task selection and completion characterization functions, e.g., such functions related to service provider capabilities, proximity to the intended task completion location, and so on and so forth.

The processor 302 may execute instructions from memory 318, as shown by the functions 310, to match and/or link customers with suitable corresponding service providers capable of handling their task and who are geographically located within a reasonable (e.g., customer pre-defined) geographic proximity and/or location from the intended task completion site.

By way of example and not limitation, the functions 310 may include any one or more of the following: (1) a proximity to task completion location determination 304; (2) a service provider trip completion time predictor 306; (3) service provider characteristics 308. The proximity to task completion location determination 304 may at least partially consider, by assigning a proportionate weightage, how far a selected and/or suitable service provider is to an intended task completion location set by the customer. Such a weightage may factor into the service provider trip completion time predictor 306, which may consider how far the service provider is, at an initial start time and location, from the intended task completion location, as well as other conditions, such as weather, traffic, and topography of the general region, etc. Also, the functions 310 may include service provider characteristics 308, which are reflective of the type of professional and/or para-professional service intended to be rendered by the service provider, and which may or may not factor into either of 304 or 306, or 304 and 306.

By way of example and not limitation, the processor 302 may process any one or more of customer service requests and/or service provider availability responses to assist in matching customers to service providers based on any one or more of the 310. In a variation, the service provider characteristics 308 can enable ranking or scoring, so that a selected service provider may be one that best satisfies the customer's request, e.g., such that service providers with skill sets particularly well-matched to the requested task at hand may be scored and/or ranked higher than those who are not. Additionally, the processor 302 can execute the service provider trip completion time predictor to predict a trip completion time for a selected service provide to arrive at a task completion location, given the parameters of the request as set by the customer.

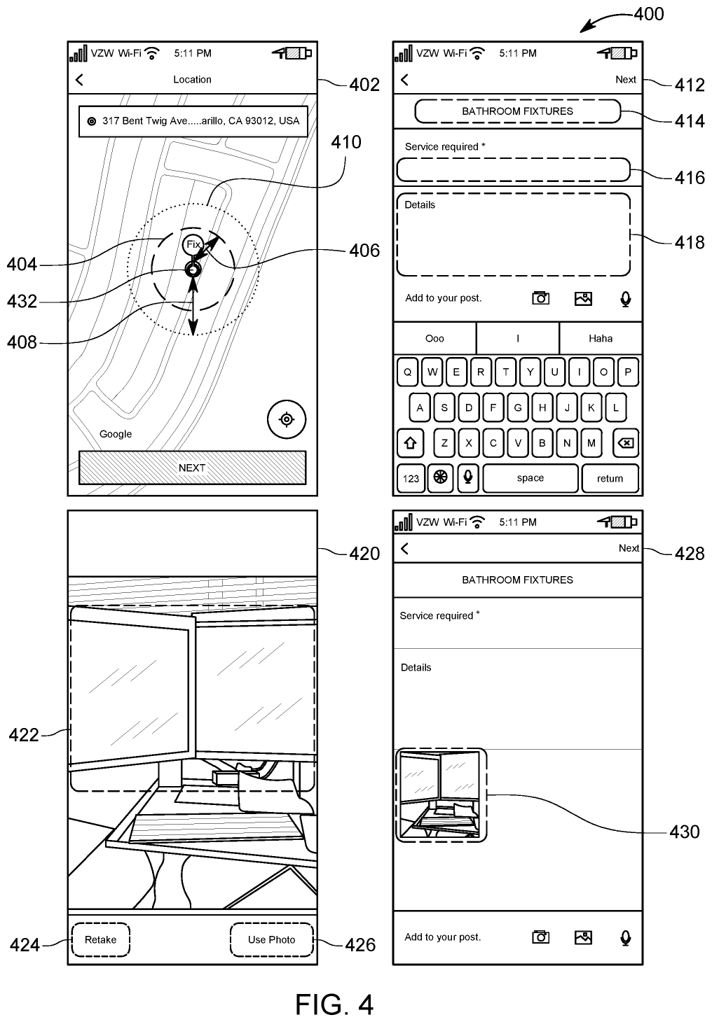

FIG. 4 illustrates various screen captures of a computer-based application, e.g., an “app” such as the “Fixense” app shown and discussed elsewhere in the FIGs., related to the identification of a geographic location of a task intended for completion and input of various request related data further characterizing the specifics of the task, in accordance with an embodiment of the presently disclosed embodiments. In the present embodiment, various screen captures 400 include a location input and/or identification screen 402, a task description screen 412, a content capture screen 420, and a content input screen 428. By way of example and not limitation, in one or more embodiments, the task description screen 412 and the content input screen 428 may be equivalent and/or substantially the same.

Similar to that first introduced earlier in connection with the customer-to-service provider system 200, the location input and/or identification screen 402 includes a task completion location 432, which may be where the customer/s is/are located while he, she, they and/or it place a request for the completion of a service-oriented task via the smartphone-installable “Fixense” app depicted in the screen captures 400. The location of one or more service providers potentially suitable for completion of the requested tasks may be further categorized according to a distance from the task completion location 432. That is, the location input and/or identification screen 402 may include and/or depict underlying functionality related to the setting of a first proximity 404 at a first radius 406 and a second proximity 410 at a second radius 408, where first radius 406 and second radius 408 may be drawn and/or calculated in a radially outward direction from the task completion location 432. For example, if a service provider with home/office based in Westminster, Calif., with a chosen 60 mile radius distance travel took a job in Riverside, Calif., then from his or her job site in Riverside he or she may receive another job post 30 miles further towards Palm Springs, Calif., he or she can still see the job post even it is now approximately 75 miles from his home/office which has exceeded his home/office based chosen radius by 15 miles. Thus, the app permits for automatic self-updating regarding the radius from which the service provider is able to serve base on real-time data regarding the service provider's exact geographic location at a particular time and is not restricted to the original start location of the service provider. Therefore, should this same service provider travel elsewhere, his or her service radius may be centered around where he or she is currently, rather than where he or she started out from earlier in the day. Those skilled in the art will appreciate that the sequential configuration of proximities defined by increasing radii from the task completion location is provided as an example and that other alternative, fewer, or additional parameters may exist and/or be implementation to define a spatial relationship between the customer at the service request location and the service provider.

Generally, a further distance of the service provider to the customer will result in a lower weightage provided thereto regarding selection and/or presentation of that service provider to the customer for selection, and vice-versa. However, those skilled in the art will appreciate that such factors may be out-weighed by other influencing factors such as the relative match of the services provided by the service provider and the task requested for completion by the customer, e.g., such that a tighter and/or closer match may, in fact, out-weigh a further distance of that service provider to the customer. Such details are described earlier in the various systems 100-300 shown and described in connection with FIGS. 1-3, for example.

Subsequent to the entry and/or tabulation of task completion location 432 at location input and/or identification screen 402, task description screen 412 may be displayed indicative of a particular task selected for completion. In alternative embodiments, the task description screen 412 may be displayed to the customer for viewing and entry of input therein at any time, e.g., at a screen prior to the display of a location input and/or identification screen 402 such as after launch screen 206 as shown and described in connection with FIG. 2. The customer may input a description into a service required field 416 and/or details 418 related thereof, where a written representation of what type of task or service has been selected, e.g., at the launch screen 206, may be included at indicia location 414. Those skilled in the art will appreciate the description of “BATHROOM FIXTURES” is provided by way of example only and that other options exist as selectable by the customer from the launch screen 206. Such written description may be parsed and/or processed automatically by the “Fixense” app to be uploaded to a centralized “cloud”-based database for either automatic detection and understanding via computer science related functionality, e.g., artificial intelligence, etc., and/or may otherwise be interpreted by real-live humans to match and/or link and/or post the customer's request to a database and/or posting list visible to qualified, pre-screened service providers who may then provide price quotes and/or bids to the customer for selection and/or finalization of the task completion process.

By way of example and not limitation, the task description screen 412 may be replaced and/or supplemented by the content capture screen 420, which may permit for the customer to take and/or create a video recording 422 (which may include audio content as well) representative of the task required for completion, e.g., set-up and/or cable management as associated with a home office, or bathroom fixtures, and so on and so forth. Those skilled in the art will appreciate that the video recording capabilities of the content capture screen 420 are provided as an example only, and that the content capture screen may accommodate other forms of digital media recordation, including (but not limited to): audio, and static photos/screen shots. The content capture screen 420, upon the customer's taking a video, photo, etc., may elect to either retake 424 the same or use 426, where such content may then be integrated with the content input screen 428 to supplement or replace the customer's description of the task at hand, etc. A visual representation of digital media content captured at the content capture screen 420 may be included at a location 430 of the content input screen.

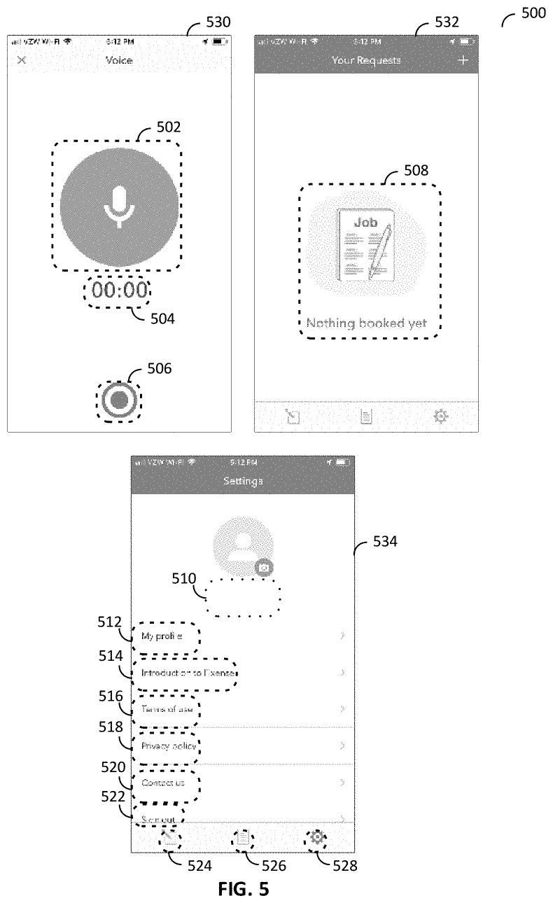

FIG. 5 illustrates additional screen captures of the app related to the recording of an audio and/or audial representation of the task intended for completion, booking of the task, and general customer profile related settings, in accordance with an embodiment of the presently disclosed embodiments. Screen captures 500 may be consistent with the “Fixense” app introduced and discussed earlier and in connection with the FIGs., and may include a voice memo input screen 530, a request booking confirmation screen 532, and a general settings screen 534. Those skilled in the art will appreciate that additional or fewer such screens may exist other than that shown by the screen captures 500 regarding overall functionality of the “Fixense” app without departing from the scope and spirit of the presently disclosed embodiments.

By way of example and not limitation, in one or more embodiments, an electronic payment form may be provided to the requester or user in the form of a screen for submission of monetary payment therein once the optimal service provider satisfactorily completes the task-related request. Payment, as electronically submitted by the customer upon satisfactory rendering of services as requested by the service provider, may be accomplished by any number of means, including the following: cash, check, electronic money wire transfer, etc., and may be paid directly to service provider when the work is done and inspected by the customer. The exact form of payment may depend on the particulars of the service provider's preferences, such as permitting for a given service provider to select a preferred method of payment he or she prefers, e.g., upon creation of the respective service provider profile of the app and/or at a later time.

Also, in one or more embodiments, there may be a “Work Order” page and/or screen that, for example, both the customer and service provider may acknowledge prior to the service provider beginning work on the posted job. Moreover, in that “Work Order” page, there may be one or more payment methods that both parties, e.g., the requesting customer and the service provider, may and/or must acknowledge and/or confirm prior to the completion of a successful transaction, e.g., closing the transaction. All of these various steps and/or action items may be completed prior to the service provider starting to work. Also, in one or more embodiments, the “Work Order” page or screen may include a warranty provided by the service provider; plus, a total price quoted with itemized, task-by-task details. Still further, in some embodiments, the “Work Order” page may be created after service provider has arrived at the job site and provided a final quote and other details including warranty, if available. Also, by way of example and not limitation, Fixense may initially not charge any fees to customers, referring to app users and service providers both. Nevertheless, app capabilities and functionality may permit Fixense, to charge service providers an annual fee (e.g., as Amazon charges its Prime members an annual fee, where such a fee may begin at a set dollar amount, e.g., $39 a year in US (where such an annual fee may differ from country to country) and may increase annually or at any given time with prior notice and announcement. In some embodiments, on top of member annual fee, Fixense may also collect a percentage fee and/or commission, such as 10%, as a labor fee only, not for necessary parts/material, from service providers. Fees may be collected based at least partially on labor fees listed on the “Work Order” page mentioned earlier.

Other forms may include service provider-oriented customer rating forms, relating to and permitting for service providers to rate and/or review customers based on any one or more factors, such as (but not limited to): ease of doing business with the customer, payment history and/or promptness, relative preparedness of the customer to facilitate completion of the task and/or job, and so on and so forth. Those skilled in the art will appreciate that the example screens are non-exhaustive and that suitable screens other than that described here may be included without departing from the scope and spirit of the presently disclosed embodiments.

Returning to that shown in FIG. 5, voice memo input screen 530 may be presented to the customer and/or may appear in any order and permit for the customer to speak a verbal description to create a recording 502 of a specified duration 504 by pressing the record button 506 regarding the task intended for completion, e.g., “I require assistance in setting up a home office. I have with me, in my possession, a desktop computer, two flat-screen monitors and associated desktop clamping assembly, and a wireless keyboard and mouse, all as-shipped in their original boxes, as well as a small corner desk requiring complete assembly. Ideally, a skilled handy person may take on this task to assemble the desk, place the desktop computer thereon, and assemble the desktop clamping assembly for the desktop monitors to complete the home office set-up. I will also need assistance in dressing-up and/or managing any resultant cables produced from making the various connections needed with these pieces of computing equipment, etc. Please advise.”

The recording may be subsequently uploaded and/or forwarded to an off-site, e.g., remote to the customer and any one or more of the service providers, “cloud”-based (not shown in FIG. 5) processing location for discernment by either fully automated computer-based functionality, e.g., artificial intelligence, and/or real-live humans, either of whom may understand the recording 502 to present the same to specific qualified service providers such that they may, correspondingly, provide price quotes related to completion of the job task for viewing by the customer and final selection therefrom, e.g., regarding selecting an optimal service provider from a sub-set of preferred service providers, as defined as being within a specific geographic proximity as introduced in the other FIGs., and so on and so forth. Selection of an optimal service provider may appear in the request booking confirmation screen 532 and in a booking confirmation area 508. Successful booking of a task intended for completion in the booking confirmation area 508 may also permit (not shown in the FIGs.) for geographic tracking of the optimal and/or selected service provider traveling en route from its origin and/or start location to the task completion location to display such information in real-time to the customer for review, etc.

In addition to any one or more of the screens shown, the “Fixense” app shown and described in connection with the FIGs. may also include the general settings screen 534, which may be accessible and/or able to be initiated by the customer at any time by, for example (but not limitation thereto), pressing a related settings button 528. Similar such buttons may exist for the entry of task related information at an entry button 524, and/or a booking confirmation access button 526. Those skilled in the art will appreciate that the buttons, and functionality related thereto, are provided as examples only and that a greater or fewer number of buttons may exist without departing from the scope and spirit of the present embodiments.

Returning to the general settings screen 534, the customer's name may be displayed at a customer name display region 510 and the customer may input information relation to his, her, their and/or its profile at a my profile input area 512, may view an introduction to the “Fixense” app at an introduction to Fixense area 514, may view a terms of use at a terms of use area 516, may view the privacy policy related to the “Fixense” app at a privacy policy 518 viewing area, may contact the “Fixense” app management tram at a contact us area 520, and may sign out of the “Fixense” app at a sign out area 522. Those skilled in the art will appreciate that a greater or fewer number of functional areas may be presented within the general settings screen 534 without departing from the scope and spirit of the disclosed embodiments.

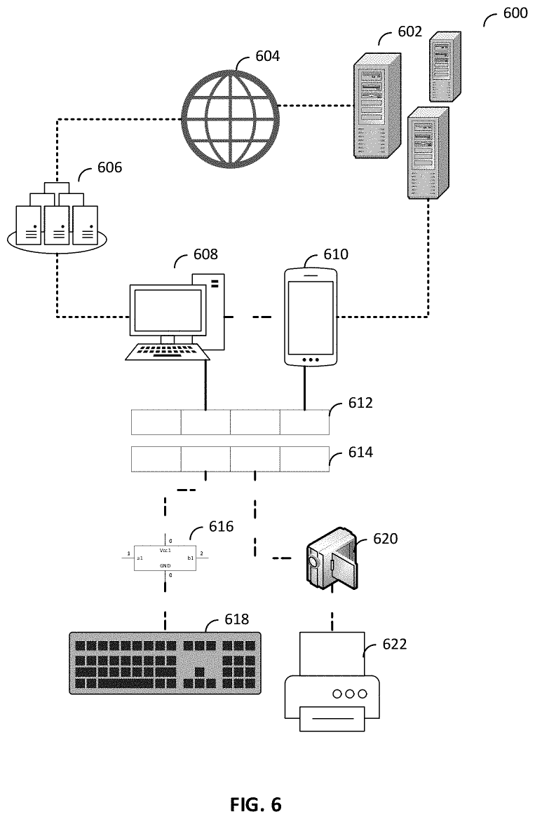

FIG. 6 illustrates a block diagram depicting an example client/server system which may be used by an example web-enabled/networked embodiment of the presently disclosed embodiments. The communication system 600 may work in tandem with and/or otherwise supplement and/or integrate with any one or more of the systems 100-500 shown and discussed in connection with FIGS. 1-5, respectively. Accordingly, the communication system 600 may facilitate functionality regarding wireless telecommunications via cellular telephone networks and/or the Internet as related to connecting, linking and/or permitting for communications between at least the customer, one or more service providers, geographic positioning services capable of locating the customer and the one or more service providers, and an off-site (e.g., relative to the customer and/or the one or more service providers) “cloud”-based computation site, e.g., at least partially executed by computer-based processors on a physical server and/or database, to process information related to the general functioning of the “Fixense” app as so described earlier.

The communication system 600 may include a multiplicity of clients 608, 610, e.g., including personal computers and/or smartphones and/or devices, a multiplicity of local networks 606, a global network 604 (e.g., the Internet) and a multiplicity of servers 602. Clients 608, 610 may communicate bi-directionally with local network 606, which may communicate bi-directionally with global network 604, which may communicate bi-directionally with servers 602. Further, clients 608, 610, local network 606, global network 604, and servers 602 may communicate bi-directionally with each other.

By way of example and not limitation, global network 604 may operate as the Internet; moreover, those skilled in the art will appreciate that communication system 600 may take many different forms, including (but not limited to) any one or more of the following: local area networks (LANs), wide area networks (WANs), wired telephone networks, wireless networks, or any other network for data communication between corresponding entities.

Likewise, clients 608, 610, currently shown as a personal computer and a smartphone, respectively, may take various other forms and that shown by FIG. 6 is provided as a non-limiting example. Other types of suitable clients include (but are not limited to): table computers, all-in-one personal computers, smart device other than smartphones, and so on and so forth.

In one of more embodiments, clients 608, 610 may have a processor, such as a CPU 616, a pointing device (not shown in FIG. 6), a keyboard 618, a microphone (not shown in FIG. 6), a printer 622, a memory 612, a mass memory storage 614, a GUI (not shown in FIG. 6), a video camera 620, an input/output interface (not shown in FIG. 6) and a network interface (not shown in FIG. 6).

Any one or more of the devices and/or systems 602-622 and others as mentioned above may electronically communicate in a unidirectional manner or a bi-directional manner with each other through one or more communication channel, which may be configured as a single communication channel or a multiplicity of communication channels.

CPU 616 may be comprised of a single processor or multiple processors, and, in one or more embodiments, may be of various types including micro-controllers (e.g., with embedded RAM/ROM) and microprocessors such as programmable devices (e.g., RISC or SISC based, or CPLDs and FPGAs) and devices not capable of being programmed such as gate array ASICs (Application Specific Integrated Circuits) or general-purpose microprocessors.

Those skilled in the art will appreciate that memory 612, 614 may be used typically to transfer data and instructions to CPU 616 in a bi-directional manner. Mass memory storage 614 may be used to store programs, data and the like and is typically a secondary storage medium such as a hard disk. It will be appreciated that the information retained within mass memory storage 614, may, in appropriate cases, be incorporated in standard fashion as part of memory 612 as virtual memory.

In one or more embodiments, CPU 616 may be functionally coupled to a guided user interface (“GUI”) operatively associated with the clients 608, 610, where the GUI enables a user to view the operation of, for example (but not limitation thereto) computer operating system and software. CPU 616 may, in one or more embodiments, be operatively coupled to pointing device, such as (but not limited to): a computer mouse, trackball and touchpad. The pointing device may enable a human user with the capability to maneuver a computer cursor about the viewing area of GUI to select and/or otherwise interact with areas or features therein. CPU 616 may be functionally coupled to keyboard 618, which enables a user with the capability to input alphanumeric textual information to CPU 616. CPU 616 may also be coupled to a microphone (not shown in FIG. 6), which enables audio produced by a user to be recorded, processed and communicated by CPU 616. In one or more embodiments, CPU 616 may be operatively coupled with printer 622, which enables a user with the ability to print content to a sheet of paper. CPU 616 may be also be operatively coupled with video camera 620. Video camera 620 enables video produced or captured by user to be recorded, processed and communicated by CPU 616.

CPU 616 optionally may be coupled to a network interface (not shown in FIG. 6) which enables communication with an external device such as a database or a computer or telecommunications or internet network using an external connection shown generally as communication channel, which may be implemented as a hardwired or wireless communications link using suitable conventional technologies. With such a connection, CPU 616 may receive information from the network, or might output information thereto in the course of performing that shown and discussed by the presently disclosed embodiments.

### Advantages

Disclosed embodiments relate to methods and systems for more efficiently and effectively capturing customer related needs regarding the scheduling of a task-related request to forward such a request to suitable nearby professional and para-professional service providers in various technical areas related to home repair, home appliance repair, computer repair, and other household related tasks, such as dog walking, gardening, etc. By seamlessly integrating task recognition capabilities, computer-based and/or human-involved, for quickly understanding what a customer's particular task-related needs are, the “Fixense” app, as so described by the above embodiments, is able to significantly reduce the wait time commonly associated with the sending of such request information to inappropriate and/or mis-matched service providers, service providers outside of a certain pre-defined service radius and/or area threshold limit, and/or other enumerated parameters input by the customer and/or the service providers. Specific services are thus provided efficiently, while also providing for the capability of customers to track a service provider selected to provide an intended service in real-time to accurately predict a time of arrival at the job site and/or task completion location. Such holistic functionality permits for a single-stop computer-based solution allowing for the convenient addressing of customer-originate service needs without the express need of outside assistance and/or solutions.

All references, including granted patents and patent application publications, referred herein are incorporated herein by reference in their entirety.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

Having fully described at least one embodiment of the present invention, other equivalent or alternative methods of implementing providing real-time geographic tracking data of a service provider traveling en route to a task completion location in response to a request placed by a customer, and, more particularly, concerned with a process involving computer-assisted intelligent and/or human-based recognition of a particular task, where a depiction of that task is electronically forwarded to real service providers for the hierarchical ranking of the service providers based on a number of factors, including distance from the task completion location, quoted prices for services rendered, and overall match of the service providers capabilities and/or skills and the type of task requested for completion according to the present invention will be apparent to those skilled in the art. Various aspects of the invention have been described above by way of illustration, and the specific embodiments disclosed are not intended to limit the invention to the particular forms disclosed. The particular implementation of the customer task service request initiation and linking to suitable service providers with tracking functionality provided thereof may vary depending upon the particular context or application. By way of example, and not limitation, the customer service request fulfilment and tracking systems and methods of use thereof described in the foregoing were principally directed to human customer, either independent and/or in groups, implementations; however, similar techniques may instead be applied to non-human computer-based customers that may be involved in providing business-to-business solutions, which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

The corresponding structures, materials, acts, and equivalents of all means or step plus function elements in the claims below are intended to include any structure, material, or act for performing the function in combination with other claimed elements as specifically claimed.

1. A non-transitory computer-readable storage medium storing one or more executable programs thereon, wherein the one or more executable programs instruct one or more processors to perform the following steps:
communicate, over a network, a task-related request from a requester to one or more service providers, the task-related request specifying a set of parameters, including a task completion location and a representation of the task-related request;
differentiate the one or more service providers based on distance from each of the one or more service providers to the requester;
automatically forward the task-related request to the one or more service providers;
provide a price quote from the one or more service providers, the one or more service providers using a smartphone, the price quote provided upon the one or more service providers being automatically notified of the task-related request via the network;
select, upon receiving corresponding input from the requester, an optimal service provider from the one or more service providers; and
display tracked movement of the optimal service provider from an initial start location to the task completion location to the requester.

2. The non-transitory computer-readable storage medium of claim 1, wherein the differentiation of the one or more service providers further involves:
determining a trip completion time for each of the one or more service providers to arrive at the task completion location;
determining one or more preferred service providers based on a hierarchical ranking of the trip completion time for each of the one or more service providers; and
restricting selection of the optimal service provider, by the requester, to any one selected from the one or more preferred service providers.

3. The non-transitory computer-readable storage medium of claim 1,
wherein the task-related request is selected from a group consisting of: an image, an audio recording, a text, and a video.

4. The non-transitory computer-readable storage medium of claim 1, further comprising generating a service provider score including consideration of: (i) a distance within a defined threshold maximum radius for each of the one or more service providers from the initial start location relative to the task completion location as set by the requester, the distance for each of the one or more service providers being based on current location information provided by geographically-aware components of a computing device of each of the one or more service providers, and (ii) an availability status of each of the one or more service providers.

5. The non-transitory computer-readable storage medium of claim 1, wherein the price quote is based on the task completion location and the representation of the task-related request.

6. The non-transitory computer-readable storage medium of claim 4, including instructions which cause the one or more processors to perform the following step:
present each of the one or more service providers according to its corresponding service provider score to the requester.

7. The non-transitory computer-readable storage medium of claim 1, including instructions which cause the one or more processors to perform the following step:
provide an electronic payment form to the requester for submission of monetary payment therein once the optimal service provider satisfactorily completes the task-related request.

8. The non-transitory computer-readable storage medium of claim 1, including instructions which cause the one or more processors to perform the following step:
identify, by the one or more executable programs, the representation of the task-related request at least partially based on contents thereof.

9. The non-transitory computer-readable storage medium of claim 8, wherein the step of identifying at least partially involves one or more capabilities selected from a group consisting of: artificial intelligence, machine learning, and computer-performed functions that mimic human cognitive functions.

10. A network computer system comprising:
one or more processors;
a set of memory resources to store a set of instructions that, when executed by the one or more processors, cause the one or more processors to:
forward, over a network, a request from a customer regarding scheduling of a task to a group of service providers, the request including a task completion location and a video recording, an audio recording or a combination thereof as a representation of the task;
identify, at least partially relying on artificial intelligence, the task based on the video recording, the audio recording or a combination thereof, to produce an identification of the task;
cross-reference the identification of the task with one or more service providers from the group of service providers who are within a defined maximum radius from the task completion location and who are skilled to perform the task to define a sub-set of preferred service providers;
automatically forward the task to the one or more service providers;
provide a price quote from the one or more service providers, the one or more service providers using a smartphone, the price quote provided upon the one or more service providers being notified of the task via the network;
organize the sub-set of preferred service providers based on the price quote to produce a hierarchy, lower price quotes receiving greater weightage resulting in preferential placement on the hierarchy;
display the hierarchy to the customer to permit for selection of an optimal service provider by the customer from the sub-set of preferred service providers;
reserve the optimal service provider at the task completion location at an appointment time; and
display tracked movement of the optimal service provider from a start location to the task completion location.

11. The network computer system of claim 10, wherein the one or more processors caused to track at least partially involves usage of global positioning service functionality.

12. The network computer system of claim 10, wherein the one or more processors caused to identify the task further involves:
usage of machine learning to automatically self-update to more accurately identify given tasks upon observing several iterations of a same or similar task.

13. The network computer system of claim 10, wherein the one or more processors are caused to:
communicate data related to a frequency of requests and successful payment history of the customer to the group of service providers.

14. (canceled)

15. The network computer system of claim 10, wherein the video recording of the task includes any one or more selected from a group of: photos and video.

16. A method for selecting a service provider over a network system, the method comprising the steps of:
determining, based at least partially on input data from a client device, that a customer has initiated a task request by specifying a particular task from a group of available tasks;
cross-referencing the particular task selected by the customer against a group of service providers within a pre-defined service area of the customer;
linking the customer to one or more service providers based on: (1) the particular task specified from the group of available tasks; and, (2) any given service provider's ability to successfully complete the particular task within a prescribed time of arrival and duration of completion;
automatically forwarding the task-related request to the one or more service providers;
providing a price quote from the one or more service providers, the one or more service providers using a smartphone, the price quote provided upon the one or more service providers being notified of the particular task via the network system;
organizing linked service providers into a hierarchy based on the price quote for completing the particular task provided by each of the one or more service providers;
presenting the hierarchy to the customer for the selection of an optimal service provider therefrom; and
displaying tracking information of the optimal service provider from a start location to the customer.

17. The method for selecting the service provider over the network system of claim 16, wherein the group of available tasks includes that selected from a group consisting of: bathroom fixtures, bathroom remodels, cabinetry, carpentry, carpet, chimneys and fireplaces, decks, doors, drywall, electrical, fencing, garage doors, gas installation and repair, gutters, heating, ventilation, and cooling, indoor and outdoor lighting, kitchen fixtures, kitchen remodels, laminate flooring, leak detection and repair, locksmith services, masonry, painting, plumbing, roofing, sewers and drains, sprinklers, swimming pools, tile flooring, wallpaper, windows, and wood flooring.

18. The method for selecting the service provider over the network system of claim 16, wherein the group of available tasks includes providing service to any one selected from a group consisting of: air conditioners, barbeque grills, ceiling fans, clothes dryers, clothes washers, coffee makers, dishwashers, freezers, garbage disposals, heating systems, microwave ovens, ovens, refrigerators, sewing machines, stoves, toasters/toaster ovens, vacuums, wall mounted air conditioners, water coolers, and water heaters.

19. The method for selecting the service provider over the network system of claim 16, wherein the group of available tasks includes any one selected from a group consisting of: clean-outs, gardening, house cleaning, moving, snow removal, and tree service.

20. The method for selecting the service provider over the network system of claim 16, wherein the group of available tasks includes providing service to any one selected from a group consisting of: audio-visual equipment, cell phones, desktop computers, laptops, modems/routers, tablets, televisions, and portable electronic devices.
